(19) United States
(12) Patent Application Publication
(10) Pub. No.: US 2025/0344220 A1
(43) Pub. Date: Nov. 6, 2025

(54) CONTROL RESOURCE SET DETERMINATION FOR ENHANCED REDUCED-CAPABILITY USER EQUIPMENTS

(71) Applicant: QUALCOMM Incorporated, San Diego, CA (US)

(72) Inventors: Hung Dinh LY, San Diego, CA (US); Yongjun KWAK, San Diego, CA (US); Kexin XIAO, Shanghai (CN); Wanshi CHEN, San Diego, CA (US); Krishna Kiran MUKKAVILLI, San Diego, CA (US); Peter GAAL, San Diego, CA (US); Juan MONTOJO, San Diego, CA (US)

(21) Appl. No.: 18/867,734

(22) PCT Filed: Jul. 14, 2022
(86) PCT No.: PCT/CN2022/105618

§ 371 Date: Nov. 20, 2024

(51) Int. Cl. H04W 72/231; H04W 56/00; H04W 72/02; H04W 72/0453; H04W 72/0457; H04W 72/12

(52) U.S. Cl. CPC H04W 72/231; H04W 56/0015; H04W 72/02; H04W 72/0453; H04W 72/0457; H04W 72/12

(57) ABSTRACT

Methods, systems, and devices for wireless communications are described. A user equipment (UE) is configured to receive, from a network entity, a control message indicating a control resource set (CORESET), where the CORESET is associated with a downlink bandwidth part (BWP) spanning a set of sub-bands in a frequency domain. The UE is configured to select a sub-band of the set of sub-bands based on a physical cell identifier associated with the UE, and monitor the selected sub-band for control signaling that schedules the UE to receive a system information block (SIB). The UE may then receive a second control message from the network entity within the selected sub-band based on monitoring the selected sub-band, where the second control message schedules the UE to receive the SIB.

### CROSS REFERENCE

The present Application is a 371 national stage filing of International PCT Application No. PCT/CN2022/105618 by LY et al. entitled “CONTROL RESOURCE SET DETERMINATION FOR ENHANCED REDUCED-CAPABILITY USER EQUIPMENTS,” filed Jul. 14, 2022, which is assigned to the assignee hereof, and which is expressly incorporated by reference in its entirety herein.

### TECHNICAL FIELD

The following relates to wireless communications, including control resource set (CORESET) determination for enhanced reduced-capability (eRedCap) user equipments (UEs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, wireless devices such as UEs may be configured to monitor control resource sets (CORESETs) to receive control information such as system information block (SIB) messages. An initial CORESET (e.g., CORESET0) may be configured for each UE via a master information block (MIB), where the size and location of the CORESET0 is used to determine the initial bandwidth part (BWP) that each UE is to monitor. However, some UEs may include reduced-capability (RedCap) UEs that are unable to monitor a frequency range spanned by the CORESET0.

### SUMMARY

The described techniques relate to improved methods, systems, devices, and apparatuses that support control resource set (CORESET) determination for enhanced reduced-capability (eRedCap) user equipments (UEs). Generally, aspects of the present disclosure are directed to rules and configurations for mapping sets of resources that are expected to be monitored by normal, regular-capability UEs to sets of resources that are able to be monitored by reduced-capability (RedCap) UEs, including eRedCap UEs.

A method for wireless communication at a UE is described. The method may include receiving, from a network entity, a control message indicating a CORESET, where the CORESET is associated with a downlink bandwidth part spanning a set of multiple sub-bands in a frequency domain, selecting a sub-band of the set of multiple sub-bands based on a physical cell identifier (PCID) associated with the UE, monitoring the selected sub-band for control signaling that schedules the UE to receive a system information block (SIB), and receiving a second control message from the network entity within the selected sub-band based on monitoring the selected sub-band, the second control message scheduling the UE to receive the SIB.

An apparatus for wireless communication at a UE is described. The apparatus may include at least one processor, and memory coupled to the at least one processor, the memory storing instructions executable by the at least one processor to cause the UE to receive, from a network entity, a control message indicating a CORESET, where the CORESET is associated with a downlink bandwidth part spanning a set of multiple sub-bands in a frequency domain, select a sub-band of the set of multiple sub-bands based on a PCID associated with the UE, monitor the selected sub-band for control signaling that schedules the UE to receive a SIB, and receive a second control message from the network entity within the selected sub-band based on monitoring the selected sub-band, the second control message scheduling the UE to receive the SIB.

Another apparatus for wireless communication at a UE is described. The apparatus may include means for receiving, from a network entity, a control message indicating a CORESET, where the CORESET is associated with a downlink bandwidth part spanning a set of multiple sub-bands in a frequency domain, means for selecting a sub-band of the set of multiple sub-bands based on a PCID associated with the UE, means for monitoring the selected sub-band for control signaling that schedules the UE to receive a SIB, and means for receiving a second control message from the network entity within the selected sub-band based on monitoring the selected sub-band, the second control message scheduling the UE to receive the SIB.

A non-transitory computer-readable medium storing code for wireless communication at a UE is described. The code may include instructions executable by a processor to receive, from a network entity, a control message indicating a CORESET, where the CORESET is associated with a downlink bandwidth part spanning a set of multiple sub-bands in a frequency domain, select a sub-band of the set of multiple sub-bands based on a PCID associated with the UE, monitor the selected sub-band for control signaling that schedules the UE to receive a SIB, and receive a second control message from the network entity within the selected sub-band based on monitoring the selected sub-band, the second control message scheduling the UE to receive the SIB.

In some examples of the method, apparatuses, and non-transitory computer-readable medium described herein, each sub-band of the set of multiple sub-bands may be associated with a respective sub-band identifier and the method, apparatuses, and non-transitory computer-readable medium may include further operations, features, means, or instructions for selecting the sub-band associated with a lowest sub-band identifier from the set of multiple sub-bands based on the PCID including an odd numbered PCID and selecting the sub-band associated with a highest sub-band identifier from the set of multiple sub-bands based on the PCID including an even numbered PCID.

Some examples of the method, apparatuses, and non-transitory computer-readable medium described herein may further include operations, features, means, or instructions for selecting the sub-band based on a quantity of sub-bands included within the set of multiple sub-bands and based on the PCID.

Some examples of the method, apparatuses, and non-transitory computer-readable medium described herein may further include operations, features, means, or instructions for receiving, from the network entity, a synchronization signal block (SSB) indicating the PCID, where selecting the sub-band may be based on receiving the SSB.

Some examples of the method, apparatuses, and non-transitory computer-readable medium described herein may further include operations, features, means, or instructions for receiving, from the network entity, a SSB indicating a sub-band configuration usable by the UE for selecting the sub-band from the set of multiple sub-bands, where the sub-band may be selected from the set of multiple sub-bands in accordance with the sub-band configuration.

In some examples of the method, apparatuses, and non-transitory computer-readable medium described herein, the control message includes a master information block (MIB).

Some examples of the method, apparatuses, and non-transitory computer-readable medium described herein may further include operations, features, means, or instructions for selecting the sub-band of the set of multiple sub-bands may be based on the UE including an eRedCap UE.

A method for wireless communication at network entity is described. The method may include transmitting, to a UE, a control message indicating a CORESET, where the CORESET is associated with a downlink bandwidth part spanning a set of multiple sub-bands in a frequency domain, identifying a sub-band of the set of multiple sub-bands of the downlink bandwidth part associated with the CORESET based on a PCID associated with the UE, and transmitting a second control message to the UE within the identified sub-band, the second control message scheduling the UE to receive a SIB.

An apparatus for wireless communication at network entity is described. The apparatus may include at least one processor, and memory coupled to the at least one processor, the memory storing instructions executable by the at least one processor to cause the network entity to transmit, to a UE, a control message indicating a CORESET, where the CORESET is associated with a downlink bandwidth part spanning a set of multiple sub-bands in a frequency domain, identify a sub-band of the set of multiple sub-bands of the downlink bandwidth part associated with the CORESET based on a PCID associated with the UE, and transmit a second control message to the UE within the identified sub-band, the second control message scheduling the UE to receive a SIB.

Another apparatus for wireless communication at network entity is described. The apparatus may include means for transmitting, to a UE, a control message indicating a CORESET, where the CORESET is associated with a downlink bandwidth part spanning a set of multiple sub-bands in a frequency domain, means for identifying a sub-band of the set of multiple sub-bands of the downlink bandwidth part associated with the CORESET based on a PCID associated with the UE, and means for transmitting a second control message to the UE within the identified sub-band, the second control message scheduling the UE to receive a SIB.

A non-transitory computer-readable medium storing code for wireless communication at network entity is described. The code may include instructions executable by a processor to transmit, to a UE, a control message indicating a CORESET, where the CORESET is associated with a downlink bandwidth part spanning a set of multiple sub-bands in a frequency domain, identify a sub-band of the set of multiple sub-bands of the downlink bandwidth part associated with the CORESET based on a PCID associated with the UE, and transmit a second control message to the UE within the identified sub-band, the second control message scheduling the UE to receive a SIB.

In some examples of the method, apparatuses, and non-transitory computer-readable medium described herein, each sub-band of the set of multiple sub-bands may be associated with a respective sub-band identifier and the method, apparatuses, and non-transitory computer-readable medium may include further operations, features, means, or instructions for identifying the sub-band associated with a lowest sub-band identifier from the set of multiple sub-bands based on the PCID including an odd numbered PCID and identifying the sub-band associated with a highest sub-band identifier from the set of multiple sub-bands based on the PCID including an even numbered PCID.

Some examples of the method, apparatuses, and non-transitory computer-readable medium described herein may further include operations, features, means, or instructions for identifying the sub-band based on a quantity of sub-bands included within the set of multiple sub-bands.

Some examples of the method, apparatuses, and non-transitory computer-readable medium described herein may further include operations, features, means, or instructions for transmitting, to the UE, a SSB indicating the PCID, where identifying the sub-band, transmitting the second control message, or both, may be based on transmitting the SSB.

Some examples of the method, apparatuses, and non-transitory computer-readable medium described herein may further include operations, features, means, or instructions for transmitting, to the UE, a SSB indicating a sub-band configuration usable by the UE for selecting the sub-band from the set of multiple sub-bands, where the sub-band may be identified from the set of multiple sub-bands in accordance with the sub-band configuration.

In some examples of the method, apparatuses, and non-transitory computer-readable medium described herein, the control message includes a MIB.

Some examples of the method, apparatuses, and non-transitory computer-readable medium described herein may further include operations, features, means, or instructions for identifying the sub-band from the set of multiple sub-bands may be based on the UE including an eRedCap UE.

A method for wireless communication at a UE is described. The method may include receiving, from a network entity, a control message indicating a CORESET associated with a first set of resources that span a first frequency range, mapping the CORESET to an additional CORESET associated with a second set of resources that span a second frequency range that is smaller than the first frequency range based on the first frequency range exceeding a threshold frequency size, monitoring, based on the mapping, the additional CORESET for control signaling that schedules the UE to receive a SIB, and receiving a second control message from the network entity within the additional CORESET based on monitoring the additional CORESET, the second control message scheduling the UE to receive the SIB.

An apparatus for wireless communication at a UE is described. The apparatus may include at least one processor, and memory coupled to the at least one processor, the memory storing instructions executable by the at least one processor to cause the UE to receive, from a network entity, a control message indicating a CORESET associated with a first set of resources that span a first frequency range, map the CORESET to an additional CORESET associated with a second set of resources that span a second frequency range that is smaller than the first frequency range based on the first frequency range exceeding a threshold frequency size, monitor, based on the mapping, the additional CORESET for control signaling that schedules the UE to receive a SIB, and receive a second control message from the network entity within the additional CORESET based on monitoring the additional CORESET, the second control message scheduling the UE to receive the SIB.

Another apparatus for wireless communication at a UE is described. The apparatus may include means for receiving, from a network entity, a control message indicating a CORESET associated with a first set of resources that span a first frequency range, means for mapping the CORESET to an additional CORESET associated with a second set of resources that span a second frequency range that is smaller than the first frequency range based on the first frequency range exceeding a threshold frequency size, means for monitoring, based on the mapping, the additional CORESET for control signaling that schedules the UE to receive a SIB, and means for receiving a second control message from the network entity within the additional CORESET based on monitoring the additional CORESET, the second control message scheduling the UE to receive the SIB.

A non-transitory computer-readable medium storing code for wireless communication at a UE is described. The code may include instructions executable by a processor to receive, from a network entity, a control message indicating a CORESET associated with a first set of resources that span a first frequency range, map the CORESET to an additional CORESET associated with a second set of resources that span a second frequency range that is smaller than the first frequency range based on the first frequency range exceeding a threshold frequency size, monitor, based on the mapping, the additional CORESET for control signaling that schedules the UE to receive a SIB, and receive a second control message from the network entity within the additional CORESET based on monitoring the additional CORESET, the second control message scheduling the UE to receive the SIB.

Some examples of the method, apparatuses, and non-transitory computer-readable medium described herein may further include operations, features, means, or instructions for receiving a CORESET mapping configuration for mapping CORESETs, where the first CORESET may be mapped to the second CORESET in accordance with the CORESET mapping configuration.

In some examples of the method, apparatuses, and non-transitory computer-readable medium described herein, the first set of resources associated with the CORESET spans a first set of symbols in a time domain and the second set of resources associated with the additional CORESET spans a second set of symbols in the time domain that may be greater than the first set of symbols.

Some examples of the method, apparatuses, and non-transitory computer-readable medium described herein may further include operations, features, means, or instructions for receiving, via the control message, a first CORESET index associated with the CORESET and mapping the first CORESET index to a second CORESET index associated with the additional CORESET.

Some examples of the method, apparatuses, and non-transitory computer-readable medium described herein may further include operations, features, means, or instructions for receiving a data object including a set of multiple CORESET indices corresponding to a set of multiple CORESET indices, where mapping the first CORESET index to the second CORESET index may be based on referencing the data object.

Some examples of the method, apparatuses, and non-transitory computer-readable medium described herein may further include operations, features, means, or instructions for mapping the CORESET to the additional CORESET may be based on a set of parameters and the set of parameters include a quantity of CORESETs that may be capable of being monitored by the UE, a first quantity of symbols spanned by the CORESET in a time domain, a second quantity of symbols spanned by the additional CORESET in the time domain, a resource block offset value, or any combination thereof.

Some examples of the method, apparatuses, and non-transitory computer-readable medium described herein may further include operations, features, means, or instructions for receiving, from the network entity, a third control message indicating a third CORESET associated with a third set of resources that span a third frequency range, monitoring the third CORESET for additional control signaling based on the third frequency range failing to satisfy a threshold frequency range associated with the UE, and receiving a fourth control message from the network entity within the third CORESET based on monitoring the third CORESET.

In some examples of the method, apparatuses, and non-transitory computer-readable medium described herein, the control message includes a MIB.

A method for wireless communication at a network entity is described. The method may include transmitting, to a UE, a control message indicating a CORESET associated with a first set of resources that span a first frequency range, mapping the CORESET to an additional CORESET associated with a second set of resources that span a second frequency range that is smaller than the first frequency range based on the first frequency range exceeding a threshold frequency size, and transmitting a second control message to the UE within the additional CORESET based on the mapping, the second control message scheduling the UE to receive a SIB.

An apparatus for wireless communication at a network entity is described. The apparatus may include at least one processor, and memory coupled to the at least one processor, the memory storing instructions executable by the at least one processor to cause the network entity to transmit, to a UE, a control message indicating a CORESET associated with a first set of resources that span a first frequency range, map the CORESET to an additional CORESET associated with a second set of resources that span a second frequency range that is smaller than the first frequency range based on the first frequency range exceeding a threshold frequency size, and transmit a second control message to the UE within the additional CORESET based on the mapping, the second control message scheduling the UE to receive a SIB.

Another apparatus for wireless communication at a network entity is described. The apparatus may include means for transmitting, to a UE, a control message indicating a CORESET associated with a first set of resources that span a first frequency range, means for mapping the CORESET to an additional CORESET associated with a second set of resources that span a second frequency range that is smaller than the first frequency range based on the first frequency range exceeding a threshold frequency size, and means for transmitting a second control message to the UE within the additional CORESET based on the mapping, the second control message scheduling the UE to receive a SIB.

A non-transitory computer-readable medium storing code for wireless communication at a network entity is described. The code may include instructions executable by a processor to transmit, to a UE, a control message indicating a CORESET associated with a first set of resources that span a first frequency range, map the CORESET to an additional CORESET associated with a second set of resources that span a second frequency range that is smaller than the first frequency range based on the first frequency range exceeding a threshold frequency size, and transmit a second control message to the UE within the additional CORESET based on the mapping, the second control message scheduling the UE to receive a SIB.

Some examples of the method, apparatuses, and non-transitory computer-readable medium described herein may further include operations, features, means, or instructions for transmitting a CORESET mapping configuration for mapping CORESETs, where the first CORESET may be mapped to the second CORESET in accordance with the CORESET mapping configuration.

In some examples of the method, apparatuses, and non-transitory computer-readable medium described herein, the first set of resources associated with the CORESET spans a first set of symbols in a time domain and the second set of resources associated with the additional CORESET spans a second set of symbols in the time domain that may be greater than the first set of symbols.

Some examples of the method, apparatuses, and non-transitory computer-readable medium described herein may further include operations, features, means, or instructions for transmitting, via the control message, a first CORESET index associated with the CORESET and mapping the first CORESET index to a second CORESET index associated with the additional CORESET.

Some examples of the method, apparatuses, and non-transitory computer-readable medium described herein may further include operations, features, means, or instructions for transmitting, to the UE, a data object including a set of multiple CORESET indices corresponding to a set of multiple CORESET indices, where mapping the first CORESET index to the second CORESET index may be based on referencing the data object.

Some examples of the method, apparatuses, and non-transitory computer-readable medium described herein may further include operations, features, means, or instructions for mapping the CORESET to the additional CORESET may be based on a set of parameters and the set of parameters include a quantity of CORESETs that may be capable of being monitored by the UE, a first quantity of symbols spanned by the CORESET in a time domain, a second quantity of symbols spanned by the additional CORESET in the time domain, a resource block offset value, or any combination thereof.

Some examples of the method, apparatuses, and non-transitory computer-readable medium described herein may further include operations, features, means, or instructions for transmitting, to the UE, a third control message indicating a third CORESET associated with a third set of resources that span a third frequency range and transmitting a fourth control message to the UE within the third CORESET based on the third frequency range failing to satisfy a threshold frequency range associated with the UE.

In some examples of the method, apparatuses, and non-transitory computer-readable medium described herein, the control message includes a MIB.

### BRIEF DESCRIPTION OF THE DRAWINGS

FIG. 1 illustrates an example of a wireless communications system that supports control resource set (CORESET) determination for enhanced reduced-capability (eRedCap) user equipments (UEs) in accordance with one or more aspects of the present disclosure.

FIG. 2 illustrates an example of a wireless communications system that supports CORESET determination for eRedCap UEs in accordance with one or more aspects of the present disclosure.

FIG. 3 illustrates an example of a resource configuration that supports CORESET determination for eRedCap UEs in accordance with one or more aspects of the present disclosure.

FIG. 4 illustrates an example of a process flow that supports CORESET determination for eRedCap UEs in accordance with one or more aspects of the present disclosure.

FIG. 5 illustrates an example of a process flow that supports CORESET determination for eRedCap UEs in accordance with one or more aspects of the present disclosure.

FIGS. 6 and 7 show block diagrams of devices that support CORESET determination for eRedCap UEs in accordance with one or more aspects of the present disclosure.

FIG. 8 shows a block diagram of a communications manager that supports CORESET determination for eRedCap UEs in accordance with one or more aspects of the present disclosure.

FIG. 9 shows a diagram of a system including a device that supports CORESET determination for eRedCap UEs in accordance with one or more aspects of the present disclosure.

FIGS. 10 and 11 show block diagrams of devices that support CORESET determination for eRedCap UEs in accordance with one or more aspects of the present disclosure.

FIG. 12 shows a block diagram of a communications manager that supports CORESET determination for eRedCap UEs in accordance with one or more aspects of the present disclosure.

FIG. 13 shows a diagram of a system including a device that supports CORESET determination for eRedCap UEs in accordance with one or more aspects of the present disclosure.

FIGS. 14 through 17 show flowcharts illustrating methods that support CORESET determination for eRedCap UEs in accordance with one or more aspects of the present disclosure.

### DETAILED DESCRIPTION

In some wireless communications systems, wireless devices (e.g., user equipments (UEs)) may be configured to monitor control resource sets (CORESETs) to receive control information such as system information block (SIB) messages. An initial CORESET (e.g., CORESET0) may be configured for each UE via a master information block (MIB), where the size and location of the CORESET0 is used to determine the initial bandwidth part (BWP) that each UE is to monitor.

However, conventional CORESETs and BWPs generally span frequency ranges that are larger than those for which a reduced capability (RedCap) UE is able to monitor, such as an enhanced RedCap (eRedCap) UE. For example, some RedCap UEs exhibit limited processing capabilities and are only able to monitor a maximum of 5 MHz, where an initial CORESET0 may exhibit a frequency range of 20 MHz or greater. As such, RedCap UEs may not be able to monitor traditional CORESETs or BWPs.

Accordingly, aspects of the present disclosure are directed to rules and configurations for mapping sets of resources that are expected to be monitored by normal, regular-capability UEs to sets of resources that are able to be monitored by RedCap UEs, including eRedCap UEs.

For example, according to some aspects of the present disclosure, a RedCap UE may be configured to receive an indication of a CORESET0 associated with an initial BWP, and then select a sub-band from the initial BWP that will be monitored by the RedCap UE. In some cases, the RedCap UE may be configured to select the sub-band (in the CORESET0) within which the UE will monitor for downlink control information (DCI) that schedules the SIB1 (as opposed to the sub-band being predetermined). For instance, the RedCap UE may select a sub-band based on a physical cell identifier (PCID) associated with the RedCap UE. Moreover, the network entity or base station may also select the same sub-band based within the CORESET0 based on the PCID of the RedCap UE.

In additional or alternative implementations, aspects of the present disclosure may enable RedCap UEs (e.g., eRedCap UEs) to map regular CORESETs capable of being monitored by regular, full-capability UEs to CORESETs capable of being monitored by RedCap UEs. For example, a RedCap UE may receive a MIB indicating a CORESET, where the CORESET exhibits a frequency range that is larger than a maximum frequency range capable of being monitored by the RedCap UE. In this example, the RedCap UE may map the indicated CORESET to a new CORESET that exhibits a smaller frequency range capable of being monitored by the RedCap UE, and may subsequently monitor the new CORESET for control signaling, such as SIBs. In some cases, as compared to the originally indicated CORESET, the new CORESET may span larger quantities of symbols but may include fewer resource elements per symbol.

Aspects of the disclosure are initially described in the context of wireless communications systems. Additional aspects of the disclosure are described in the context of an example resource configuration and example process flows. Aspects of the disclosure are further illustrated by and described with reference to apparatus diagrams, system diagrams, and flowcharts that relate to CORESET determination for eRedCap UEs.

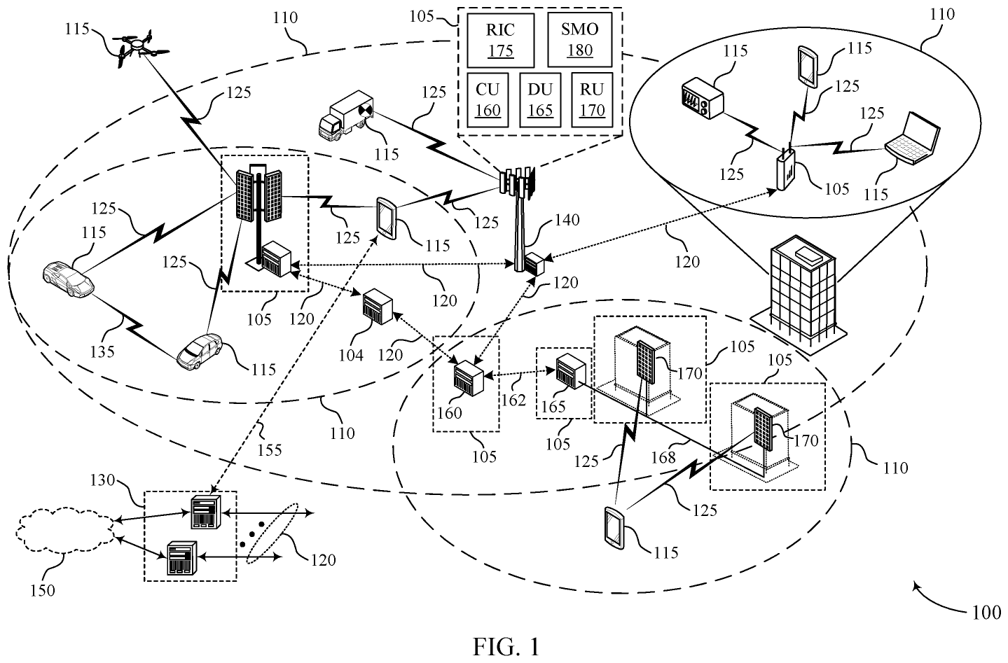

FIG. 1 illustrates an example of a wireless communications system 100 that supports CORESET determination for eRedCap UEs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support CORESET determination for eRedCap UEs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the wireless communications system 100 may support signaling, rules, and configurations for mapping sets of resources that are expected to be monitored by normal, regular-capability UEs 115 to sets of resources that are able to be monitored by RedCap UEs 115, including eRedCap UEs 115.

For example, according to some aspects of the present disclosure, a RedCap UE 115 of the wireless communications system 100 may receive an indication of a CORESET0 associated with an initial BWP that is to be monitored by the RedCap UE 115. In this example, the frequency range of the CORESET/BWP may exceed a frequency range that is capable of being monitored by the RedCap UE 115. As such, the UE 115 may be configured to select a sub-band from the initial BWP that will be monitored by the RedCap UE 115. In some cases, the RedCap UE 115 may be configured to select the sub-band (in the CORESET0) within which the UE 115 will monitor for DCI that schedules the SIB1 (as opposed to the sub-band being predetermined). For instance, the RedCap UE 115 may select a sub-band based on a PCID associated with the RedCap UE 15. Moreover, the network entity 105 may also select the same sub-band based within the CORESET0 based on the PCID of the RedCap UE 115 so that the network entity 105 knows where to communicate control signaling intended for the RedCap UE 115.

In additional or alternative implementations, the wireless communications system 100 may support techniques which enable RedCap UEs 115 (e.g., eRedCap UEs 115) to map regular CORESETs capable of being monitored by regular, full-capability UEs 115 to CORESETs capable of being monitored by RedCap UEs 115.

For example, a RedCap UE 115 of the wireless communications system 100 may receive a MIB indicating a CORESET, where the CORESET exhibits a frequency range that is larger than a maximum frequency range capable of being monitored by the RedCap UE 115. In this example, the RedCap UE 115 may map the indicated CORESET to a new CORESET that exhibits a smaller frequency range capable of being monitored by the RedCap UE 115, and may subsequently monitor the new CORESET for control signaling, such as SIBs. In some cases, as compared to the originally indicated CORESET, the new CORESET may span larger quantities of symbols but may include fewer resource elements per symbol.

Techniques described herein may enable eRedCap UEs 115 to be configured with CORESETs and/or BWPs capable of being monitored by regular, full-capability UEs 115 and identify CORESETs/BWPs that are capable of being monitored by eRedCap UEs 115. As such, aspects of the present disclosure may enable traditional control signaling used to configure CORESETs/BWPs for regular-capacity UEs 115 to be used to configure CORESETs/BWPs for eRedCap UEs 115, such as eRedCap UEs 115. As such, techniques described herein may reduce control signaling used to configure CORESETs and BWPs for regular, full-capability UEs 115 and RedCap UEs 115. Moreover, aspects of the present disclosure provide for rules, conditions, and configurations for selecting/identifying resources that will be monitored by RedCap UEs 115 so that the RedCap UEs 115 and the network can be on the same page with respect to which resources will be used to communicate control signaling to the RedCap UEs 115. As such, techniques described herein may improve an efficiency and reliability of wireless communications between RedCap UEs 115 and the network.

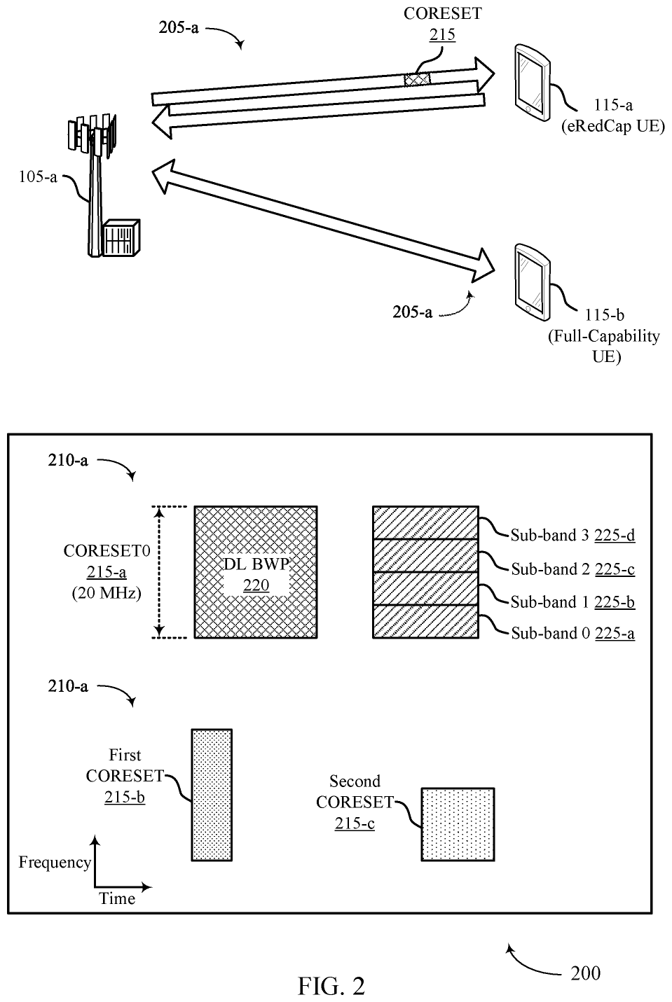

FIG. 2 illustrates an example of a wireless communications system 200 that supports CORESET determination for eRedCap UEs in accordance with one or more aspects of the present disclosure. In some examples, aspects of the wireless communications system 200 may implement, or be implemented by, aspects of the wireless communications system 100. In particular, the wireless communications system 200 may support rules or configurations for mapping sets of resources that are expected to be monitored by normal, regular-capability UEs 115 to sets of resources that are able to be monitored by RedCap UEs 115, including eRedCap UEs 115.

The wireless communications system 200 may include a network entity 105-a, a first UE 115-a (e.g., RedCap UE 115, or eRedCap UE 115), and a second UE 115-b (e.g., full-capability UE 115). The first UE 115-a and the second UE 115-b may communicate with the network entity 105-a using communication links 205-a and 205-b, respectively, which may be examples of NR or LTE links between the respective UEs 115 and the network entity 105-a. In some cases, the communication links 205 may include examples of access links (e.g., Uu links) which may include a bi-directional link that enables both uplink and downlink communication. For example, the first UE 115-a may transmit uplink signals, such as uplink control signals or uplink data signals, to one or more components of the network entity 105-a using the communication link 205-a, and one or more components of the network entity 105-a may transmit downlink signals, such as downlink control signals or downlink data signals, to the UE 115-a using the communication link 205-a.

As shown in FIG. 2, the network entity 105-a of the wireless communications system 200 may be configured to support both regular, full-capability user equipments UEs 115 as well as RedCap UEs 115. For example, the second UE 115-b may include an example of a full-capability (e.g., full-bandwidth) UE 115-b, whereas the first UE 115-a may include an example of a RedCap UE 115 (e.g., reduced-bandwidth UE 115-a), such as an eRedCap UE 115. The eRedCap UE 115-a may exhibit a reduced capability as compared to the full-capability UE 115-b with respect to one or more parameters, including a bandwidth over which it may communicate, processing capabilities, peak data rates, quantities of antennas, or any combination thereof. For instance, in some cases, the first UE 115-a may include a bandwidth capability below a given threshold, and may communicate with the network entity 105-a over a reduced bandwidth as compared to full-capability UE 115-b.

In some cases, the wireless communications system 200 may be configured to support wireless communications with wireless devices (e.g., UEs 115) that exhibit varying processing capabilities. Wireless devices may be categorized into different classes or categories of wireless devices. Classes or categories of wireless devices may include: (1) an enhanced mobile broadband (eMBB) category, (2) a RedCap category (e.g., NR-light), and (3) an eRedCap category (e.g., NR-superlight).

The eMBB category may include wireless devices that exhibit the highest complexity or performance, and may therefore include wireless devices that are able to support URLLC communications, such as high-end smartphones and high-performance sensors. Comparatively, the RedCap category may include wireless devices that exhibit lower performance/capability as compared to the eMBB category. For example, the RedCap category may include industrial wireless sensors, low-end smartphones, health monitors, video surveillance devices, high-end wearables, and high-end logistic trackers. Lastly, the eRedCap category may include wireless devices that exhibit the lowest complexity or performance, such as NB-IoT devices (e.g., massive IoT devices) and low-power wide-area (LPWA) wireless devices. For example, the eRedCap category may include low-end industrial wireless sensors, parking sensors, agricultural sensors, utility meters, low-end wearables, and low-end asset trackers.

In this regard, wireless devices categorized into the respective categories may exhibit varying complexities, processing powers, and capabilities. For example, eMBB and/or RedCap devices may be able to monitor larger spans of resources in the frequency domain as compared to eRedCap devices. For instance, eMBB devices and RedCap devices may be able to monitor a set of resources spanning up to 20 MHz in the frequency domain, whereas eRedCap devices may be able to monitor a set of resources spanning only up to 5 MHz (e.g., 24 PRB with 15 kHz SCS) in the frequency domain.

As noted previously herein, in some wireless communications systems, wireless devices (e.g., UEs 115) may be configured to monitor CORESETs to receive control information such as SIB messages. An initial CORESET (e.g., CORESET0) may be configured for each UE 115 via a MIB, where the size and location of the CORESET0 is used to determine the initial BWP that each UE 115 is to monitor. For example, referring to the first resource configuration 210-a illustrated in FIG. 2, the first UE 115-a, the second UE 115-b, or both, may be configured with a CORESET 215-a, where the CORESET 215-a is associated with an initial downlink BWP 220 that the respective UEs 115 are to monitor for control information.

However, conventional CORESETs 215 and BWPs 220 generally span frequency ranges that are larger than those for which an eRedCap UE 115 (e.g., first UE 115-a) is able to monitor. For example, as shown in the first resource configuration 210-a, the CORESET 215-a (and the initial downlink BWP 220) may span 20 MHz in the frequency domain. As a regular, full-capability wireless device (e.g., eMBB wireless device), the second UE 115-b may be able to monitor the CORESET 215-a and BWP 220. However, as an eRedCap wireless device, the first UE 115-a may be able to monitor only up to 5 MHz, and may therefore be unable to monitor the CORESET 215-a and/or BWP 220.

Accordingly, the wireless communications system 200 may support signaling, rules, and configurations for mapping sets of resources that are expected to be monitored by normal, regular-capability UEs 115 (e.g., the second UE 115-b) to sets of resources that are able to be monitored by eRedCap UEs 115, such as the first UE 115-a.

In particular, some aspects of the present disclosure support rules and configurations that enable eRedCap UEs 115 to partition a configured CORESET 215 and/or configured BWP 220 into sub-bands 225, and select one or more sub-bands 225 that will be monitored for control signaling, as illustrated in the first resource configuration 210-a. Stated differently, aspects of the present disclosure may enable cell-dependent sub-band selection for the eRedCap UE 115-a to monitor for PDCCH containing DCI with SIB1 PDSCH scheduling.

For example, referring to the first resource configuration 210-a, the first UE 115-a may receive a first control message (e.g., MIB) indicating a CORESET 215-a (e.g., CORESET0). The CORESET 215-a may be associated with the downlink BWP 220. As shown in FIG. 2, the CORESET 215-a and the BWP 220 may span 20 MHz in the frequency domain. Moreover, the FDRA associated with the BWP 220 may start from the first PRB of the BWP 220. In some aspects, the initial downlink BWP 220 may be determined by the location and size of the CORESET0 (e.g., CORESET 215-a), which may be configured via a MIB message, reconfigured via a SIB message (e.g., SIB1), or both. For example, a MIB may indicate a PDCCH configuration for receiving SIB messages (e.g., pdcch-ConfigSIB1) that includes, or is associated with, the initial CORESET 215-a (e.g., CORESET0) and a search space configuration (e.g., search space 0 configuration).

In some aspects, the BWP 220 may span a set of sub-bands 225 in the frequency domain. For example, as shown in FIG. 2, the BWP 220 may span a first sub-band 225-a (e.g., sub-band 0), a second sub-band 225-b (e.g., sub-band 1), a third sub-band 225-c (e.g., sub-band 2), and a fourth sub-band 225-d (e.g., sub-band 3). In this example, each sub-band 225 may span 5 MHz in the frequency domain. In some implementations, the first UE 115-a and/or the network entity 105-a may be configured to partition the configured downlink BWP 220 into the set of sub-bands 225. Each sub-band 225 may be associated with a corresponding sub-band identifier (sub-band ID).

Continuing with reference to the first resource configuration 210-a, the start of each sub-band 225 may be determined with respect to the PRB0 of the DL BWP 220 and based on the SCS of the BWP 220. In other words, the start of the first sub-band 225-a may be based on the first resource block and the SCS of the BWP 220 associated with the indicated CORESET 215-a. Moreover, the start of each sub-band 225 in the frequency domain may be determined based on an offset relative to PRB0 of the BWP 220. For instance, the first sub-band 225-a may be associated with a first FDRA start offset 0, the second sub-band 225-b may be associated with a second FDRA start offset 1, the third sub-band 225-c may be associated with a third FDRA start offset 2, and the fourth sub-band 225-d may be associated with a fourth FDRA start offset 3.

In some aspects, the offset for each sub-band 225 within the BWP 220 may be determined based on the maximum UE 115 bandwidth (e.g., largest bandwidth that the respective UE 115 is able to monitor). For example, offset k may be defined as k*N_{rb}, where N_{rb} is the number of resource blocks contained within maximum UE 115 bandwidth. A sub-band 225 may be considered to be valid if the respective sub-band contains a predefined number of resource blocks, such as N_{rb}. Additionally, the start of FDRA for downlink reception is the first resource block in a valid sub-band.

As noted previously herein, the CORESET 215-a and the BWP 220 may span a larger range of resources in the frequency domain than the first UE 115-a is able to monitor. That is, the first UE 115-a may only be able to monitor up to 5 MHz in the frequency domain, and may therefore be unable to monitor the entirety of the CORESET 215-a and/or the BWP 220 in the frequency domain. As such, in some implementations, the first UE 115-a may be configured to select a sub-band 225 from the BWP 220 that the UE 115-a will monitor for DCI messages used to schedule SIBs.

Stated differently, upon being configured with the CORESET 215-a (e.g., the BWP 220), the first UE 115-a may select to monitor one of the sub-bands 225 spanned by the BWP 220 in the frequency domain. In some implementations, which sub-band 225 the UE 115-a is expected to select may be predefined. For example, in some cases, the UE 115-a may be expected to select and monitor the sub-band 225 with the highest sub-band index (e.g., fourth sub-band 225-d), or the sub-band 225 with the lowest sub-band index (e.g., first sub-band 225-a). Such fixed rules may enable the network entity 105-a to easily and efficiently identify which sub-band 225 the UE 115-a is expected to select, thereby enabling the network entity 105-a to transmit control signaling (e.g., DCIs) to the first UE 115-a via the selected/expected sub-band 225. However, such fixed rules may reduce network deployment flexibility, and increase inter-cell interference.

As such, in additional or alternative implementations, the first UE 115-a may be configured to select one of the sub-bands 225 based on a PCID associated with the first UE 115-a. In some implementations, the first UE 115-a may receive an SSB message that indicates the PCID associated with the first UE 115-a.

For example, the first UE 115-a may be configured (and expected) to select the sub-band 225 with the lowest sub-band ID when the first UE 115-a is associated with an odd-numbered PCID, and may be configured to select the sub-band 225 with the highest sub-band ID when the first UE 115-a is associated with an even-numbered PCID (or vice versa). In some cases, which sub-band 225 the first UE 115-a will select to monitor may be based on the total number of valid sub-bands 225 within the initial downlink BWP 220. For example, the first UE 115-a may be configured (and expected) to select the sub-band 225 with the sub-band index that is determined according to sub−band index=mod(PCID, N), where N is the total number of valid sub-bands within the initial downlink BWP 220, PCID is the PCID of the UE 115-a, and mod represents some mathematical function used to determine which sub-band 225 will be selected.

In some aspects, the first UE 115-a may select which of the sub-bands 225 spanned by the BWP 220 will be monitored in accordance with a sub-band configuration. The sub-band configuration may indicate a set of rules or conditions that are used by the network entity 105-a and the first UE 115-a to determine which sub-band 225 the first UE 115-a is expected to select and monitor.

For example, a sub-band configuration may specify that the first UE 115-a is to select the sub-band 225 with the lowest sub-band ID when the first UE 115-a is associated with an odd-numbered PCID, and select the sub-band 225 with the highest sub-band ID when the first UE 115-a is associated with an even-numbered PCID (or vice versa). Similarly, the sub-band configuration may indicate a set of rules or conditions usable by the first UE 115-a to select one of the sub-bands 225 based on the quantity of sub-bands 225 included within the set of sub-bands 225 spanned by the BWP 220. In some aspects, the sub-band configuration may be preconfigured at the first UE 115-a, signaled to the UE 115-a, or both. For example, in some cases, the first UE 115-a may receive (from the network entity 105-a) an SSB indicating a sub-band configuration usable by the first UE 115-a for selecting the sub-band 225 from the set of sub-bands 225 spanned by the BWP 220.

Moreover, the network entity 105-a may be configured to determine or identify which sub-band 225 the UE 115-a will select in accordance with the same sub-band configuration (or other rules/conditions for selecting sub-bands 225). In this regard, the network entity 105-a and the first UE 115-a may both be on the same page as to which of the sub-bands 225 the first UE 115-a will monitor.

Upon selecting which of the sub-bands 225 the first UE 115-a is to monitor (e.g., based on a PCID associated with the first UE 115-a), the first UE 115-a may monitor the selected sub-band 225. Moreover, the UE 115-a may receive a control message within the selected sub-band 225 based on monitoring the selected sub-band 225, where the control message schedules the first UE 115-a to receive a SIB. For example, the UE 115-a may select to monitor the first sub-band 225-a, and may therefore monitor the first sub-band 225-a. In this example, the first UE 115-a may receive a DCI message within the first sub-band 225-a, where the DCI message indicates a set of resources that may be used by the first UE 115-a to receive a SIB.

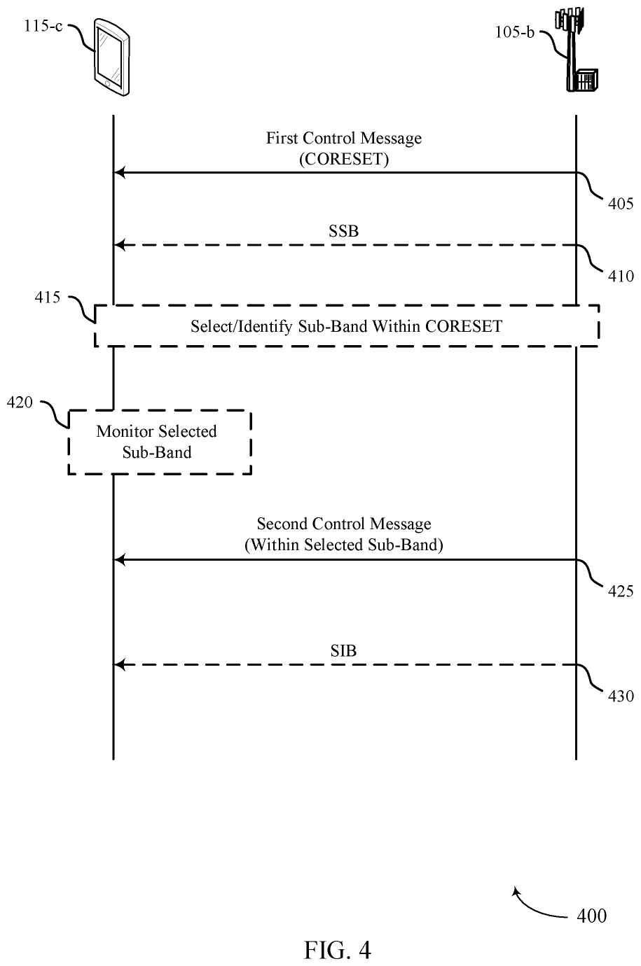

Techniques for selecting sub-bands 225 from the BWP 220, as shown in the first resource configuration 210-a, will be further shown and described with reference to FIG. 4.

Additional or alternative aspects of the present disclosure are directed to rules or configurations that enable eRedCap UEs 115 to map CORESETs 215 configured for regular, full-capability UEs 115 (e.g., second UE 115-b) to CORESETs 215 that are capable of being monitored by RedCap UEs 115, such as eRedCap UEs 115. Stated differently, some aspects of the present disclosure are directed to mapping configurations that enable eRedCap UEs 115 to derive initial CORESETs (e.g., CORESET0) for eRedCap UEs 115 from initial CORESETs configured for regular, full-capability UEs 115 and or regular RedCap UEs 115.

For example, referring to the second resource configuration 210-b, the first UE 115-a may receive a first control message (e.g., MIB) indicating a first CORESET 215-b (e.g., CORESET0). The first CORESET 215-b may be associated with the downlink BWP 220. The first CORESET 215-b may include a set of resources that spans a first frequency range. For example, as described previously herein, the first CORESET 215-a may span 20 MHz in the frequency domain.

In cases where the set of resources spanned by the first CORESET 215-b does not exceed a frequency range that the first UE 115-a is able to monitor, the first UE 115-a may be configured to monitor the configured first CORESET 215-a for control signaling. That is, if the first frequency range does not satisfy (e.g., is less than or equal to) a threshold frequency range associated with a capability of the first UE 115-a, the first UE 115-a may monitor the first CORESET 215-b.

Comparatively, in cases where the set of resources spanned by the first CORESET 215-b does exceed a frequency range that the first UE 115-a is able to monitor, the first UE 115-a may be configured to map the first CORESET 215-b to a second CORESET 215-c that the first UE 115-a is able to monitor. That is, if the first frequency range satisfies (e.g., is greater than) a threshold frequency range associated with a capability of the first UE 115-a, the first UE 115-a may map the first CORESET 215-a to a new CORESET 215 that the UE 115-a will be able to monitor. In this particular, the first UE 115-a may be configured to map the first CORESET 215-b to a second CORESET 215-c, where the second CORESET 215-b spans a smaller frequency range as compared to the first CORESET 215-b.

In some implementations, the network entity 105-a and the first UE 115-a may be configured to utilize a CORESET mapping configuration for mapping CORESETs 215. That is, the UE 115-a and the network entity 105-a may be configured to utilize a CORESET mapping configuration to map the first CORESET 215-b to the second CORESET 215-c. The CORESET mapping configuration may include a set of rules or conditions for mapping one CORESET 215 to another. In particular, the CORESET mapping configuration may include some data object that maps CORESETs 215 that are capable of being monitored by RedCap UEs 115 and/or regular, full-capability UEs 115 to CORESETs 215 that are capable of being monitored by eRedCap UEs 115. In some aspects, the CORESET mapping configuration may be preconfigured at the first UE 115-a, signaled to the UE 115-a, or both.

Upon mapping the first CORESET 215-b to the second CORESET 215-c, the first UE 115-a may monitor the second CORESET 215-c for control signaling. Moreover, the UE 115-a may receive a control message within the second CORESET 215-c based on monitoring the second CORESET 215-c, where the control message schedules the first UE 115-a to receive a SIB. For example, the UE 115-a may map the first CORESET 215-b to the second CORESET 215-c, and may therefore monitor the second CORESET 215-c. In this example, the first UE 115-a may receive a DCI message within the second CORESET 215-c, where the DCI message indicates a set of resources that may be used by the first UE 115-a to receive a SIB.

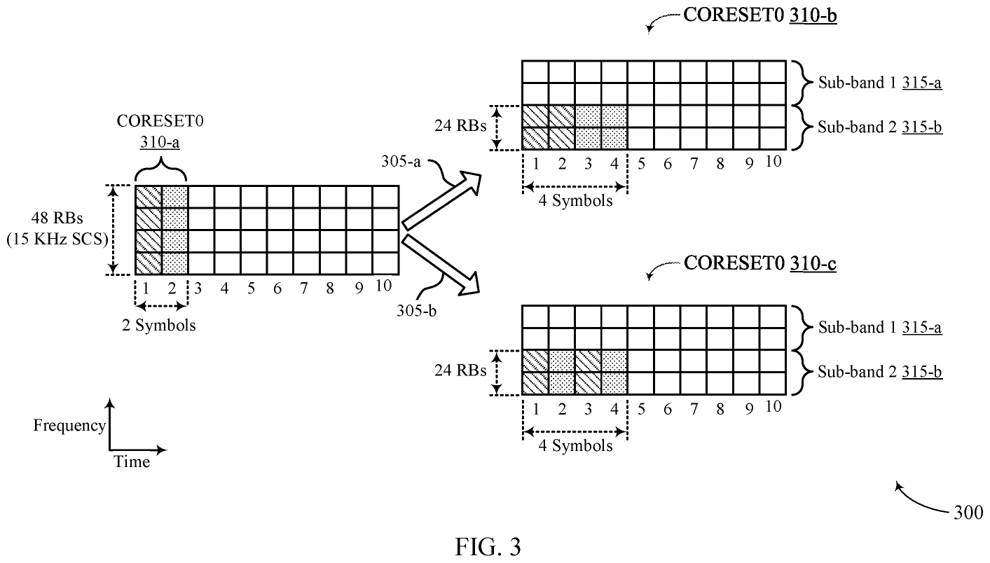

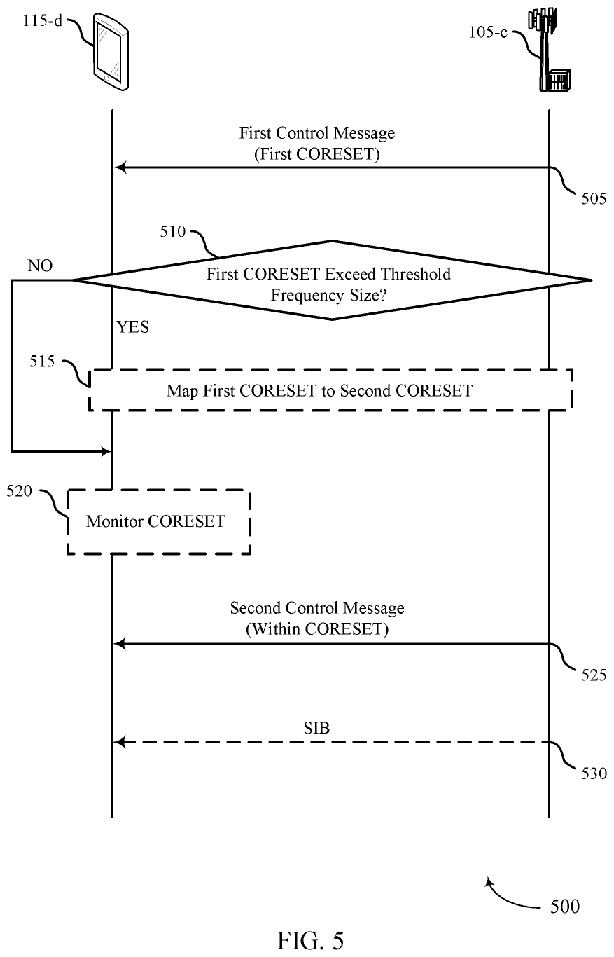

Techniques for mapping CORESETs 215 associated with RedCap UEs 115 and/or full-capability UEs 115 to CORESETs 215 associated with eRedCap UEs 115, as shown in the second resource configuration 210-b, will be further shown and described with reference to FIGS. 3 and 5.

Techniques described herein may enable eRedCap UEs 115 to be configured with CORESETs 215 and/or BWPs 220 capable of being monitored by regular, full-capability UEs 115 and identify CORESETs 215/BWPs 220 (e.g., sub-bands 225) that are capable of being monitored by eRedCap UEs 115. As such, aspects of the present disclosure may enable traditional control signaling used to configure CORESETs 215 and/or BWPs 220 for regular-capacity UEs 115 to be used to configure CORESETs 215/BWPs 220 for RedCap UEs 115, such as eRedCap UEs 115. As such, techniques described herein may reduce control signaling used to configure CORESETs 215 and BWPs 220 for regular, full-capability UEs 115 and RedCap UEs 115. Moreover, aspects of the present disclosure provide for rules, conditions, and configurations for selecting/identifying resources that will be monitored by eRedCap UEs 115 so that the eRedCap UEs 115 and the network can be on the same page with respect to which resources will be used to communicate control signaling to the eRedCap UEs 115. As such, techniques described herein may improve an efficiency and reliability of wireless communications between eRedCap UEs 115 and the network.

FIG. 3 illustrates an example of a resource configuration 300 that supports CORESET determination for eRedCap UEs in accordance with one or more aspects of the present disclosure. In some examples, aspects of the resource configuration 300 may implement, or be implemented by, aspects of the wireless communications system 100, the wireless communications system 200, or both. In particular, the resource configuration 300 illustrates different CORESET mapping configurations 305 that may be used to map CORESETs associated with RedCap UEs 115 and/or full-capability UEs 115 to CORESETs 215 associated with eRedCap UEs 115.

In some aspects, a UE 115 may be configured with a first CORESET 310-a (e.g., initial CORESET, or CORESET0). As shown in FIG. 3, the first CORESET 310-a may span 48 resource blocks in the frequency domain, and two symbols in the time domain (symbols 1 and 2). Since SSB resources are reused for eRedCap UEs 115, the SIB1 PDCCH configuration including the initial CORESET (e.g., first CORESET 310-a, or CORESET0) and search space 0 may be identical for both full-capability UEs 115, RedCap UEs 115, and eRedCap UEs 115. The first CORESET 310-a may include an example of an initial CORESET that is capable of being monitored by full-capability UEs 115 (eMBB category) and/or regular RedCap UEs 115 (RedCap or NR-light category).

In some cases, the search space 0 may be identical for regular UEs 115 and eRedCap UEs 115. However, the first CORESET 310-a may not fit into a sub-band 315 (e.g., sub-band 225 illustrated in FIG. 2), and may therefore be unable to be monitored by eRedCap UEs (eRedCap or NR-superlight category). Stated differently, the first CORESET 310-a may span more resources in the frequency domain than are capable of being monitored by an eRedCap UE 115. That is, an eRedCap UE 115 may not be able to monitor a set of resources spanning 48 resource blocks in the frequency domain, and may therefore be unable to monitor the first CORESET 310-a.

Accordingly, in cases where a size (e.g., frequency range) the configured CORESET0 is larger than the size of a sub-band 315 capable of being monitored by an eRedCap UE 115, the CORESET0 for the eRedCap UE 115 may be mapped to additional CORESET symbols. Stated differently, the first CORESET 310-a may be mapped to different CORESETs 310 (according to a CORESET mapping configuration 305), where the new CORESETs 310 span fewer resource blocks in the frequency domain, but span larger quantities of symbols in the time domain.

For example, in some implementations, an eRedCap UE 115 configured with the first CORESET 310-a may utilize a first CORESET mapping configuration 305-a to map the first CORESET 310-a to a second CORESET 310-b. As shown in FIG. 3, as compared to the first CORESET 310-a, the second CORESET 310-b may span fewer resource blocks in the frequency domain, but may span more symbols in the time domain. Specifically, the second CORESET 310-b may span 24 symbols in the frequency domain (as compared to 48 symbols in the first CORESET 310-a), and may span four symbols in the time domain (as compared to two symbols in the first CORESET 310-a).

As shown in FIG. 3, the first CORESET mapping configuration 305-a may cause the eRedCap UE 115 (and the network) to map the resources from symbol 1 of the first CORESET 310-a to symbols 1 and 2 of the second CORESET 310-b. Similarly, the first CORESET mapping configuration 305-a may cause the eRedCap UE 115 (and the network) to map the resources from symbol 2 of the first CORESET 310-a to symbols 3 and 4 of the second CORESET 310-b. Moreover, the first CORESET mapping configuration 305-a may cause the eRedCap UE 115 and the network to map the first CORESET 310-a to the second CORESET 310-b that fits within a sub-band 315 (e.g., sub-band 315-b) in the frequency domain. As such, by mapping the first CORESET 310-a to the second CORESET 310-b, the eRedCap UE 115 may be able to monitor the second CORESET 310-b for control signaling.

Reference will now be made to the second CORESET mapping configuration 305-b illustrated in FIG. 3. In some implementations, the eRedCap UE 115 may utilize the second CORESET mapping configuration 305-b to map the first CORESET 310-a to a third CORESET 310-c. As shown in FIG. 3, as compared to the first CORESET 310-a, the third CORESET 310-c may span fewer resource blocks in the frequency domain, but may span more symbols in the time domain. Specifically, the third CORESET 310-c may span 24 symbols in the frequency domain (as compared to 48 symbols in the first CORESET 310-a), and may span four symbols in the time domain (as compared to two symbols in the first CORESET 310-a).

As shown in FIG. 3, the second CORESET mapping configuration 305-b may cause the eRedCap UE 115 (and the network) to map the resources from symbol 1 of the first CORESET 310-a to symbols 1 and 3 of the third CORESET 310-c. Similarly, the second CORESET mapping configuration 305-b may cause the eRedCap UE 115 (and the network) to map the resources from symbol 2 of the first CORESET 310-a to symbols 2 and 4 of the third CORESET 310-c. The second CORESET mapping configuration 305-b may additionally cause the eRedCap UE 115 and the network to map the first CORESET 310-a to the third CORESET 310-c that fits within a sub-band 315 (e.g., sub-band 315-b) in the frequency domain. As such, by mapping the first CORESET 310-a to the third CORESET 310-c, the eRedCap UE 115 may be able to monitor the third CORESET 310-b for control signaling.

In some implementations, the eRedCap UE 115 may be configured and/or signaled to perform CORESET mapping in accordance with the first CORESET mapping configuration 305-a, the second CORESET mapping configuration 305-b, and/or an additional CORESET mapping configuration 305. Moreover, the eRedCap UE 115 and the network may be configured to utilize the same CORESET mapping configuration 305 so that the eRedCap UE 115 and the network are on the same page with respect to the format of the CORESET 310 that the eRedCap UE 115 will monitor for control signaling.

In some implementations, CORESET mapping configurations 305 may define rules or conditions for mapping CORESET indices within a data object (e.g., table) to one another. That is, a CORESET mapping configuration 305 may define rules of conditions for mapping a first CORESET index within a data object to a second CORESET index of the data object.

For example, Table 1 below illustrates configurations for initial CORESETs 315 (e.g., CORESET0) with 15 kHz SCS, where Table 2 below illustrates the number of PDCCH candidates for Type0 common search space.

TABLE 1
CORESET Configurations (15 kHz)

| | SS/PBCH | | | |
|---|---|---|---|---|
| | Block and | | | |
| | CORESET | No. of | No. of | |
| | Multiplexing | RBs | Symbols | Offset |
| Index | Pattern | (N_{RB}^{CORESET}) | (N_{Symb}^{CORESET}) | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |

| | |
|---|---|
| 15 | Reserved |

TABLE 2
Number of PDCCH Candidates for Type0 Common Search Space

| CCE Aggregation Level | Number of Candidates |
|---|---|
| 4 | 4 |
| 8 | 2 |
| 16 | 1 |

Each row illustrated in Table 1 illustrates example parameters for a respective CORESET configuration. The first column of Table 1 indicates the CORESET index for each respective CORESET configuration, and the second column indicates a CORESET multiplexing pattern for the respective CORESET. The third and fourth columns of Table 1 indicate the size of the respective CORESET in the frequency domain and the time domain, respectively, where the fifth column indicates an offset of the respective CORESET. For example, CORESET index 1 (e.g., CORESET #0-config-1) indicates a CORESET that spans 24 resource blocks in the frequency domain and two symbols in the time domain, whereas CORESET index 6 (e.g., CORESET #0-config-6) indicates a CORESET that spans 48 resource blocks in the frequency domain and one symbol in the time domain.

As noted previously herein, some eRedCap UEs 115 may only be able monitor a limited number of resource blocks in the time domain. For example, in some cases, an eRedCap UE 115 may be able to monitor a maximum downlink bandwidth of 5 MHz (25 PRBs). In this regard, eRedCap UEs 115 may be able to monitor CORESETs associated with CORESET indices 0 through 5, as such CORESETs span less than the maximum downlink bandwidth that is capable of being monitored by the eRedCap UEs 115. In other words, CORESETs associated with CORESET indices 0-5 may fit within a 5 MHz sub-band that is capable of being monitored by the eRedCap UE 115.

In this regard, in cases where an eRedCap UE 115 is configured (e.g., via MIB, SIB1) with a CORESET corresponding to any of CORESET indices 0-5, the eRedCap UE 115 may be able to monitor the configured CORESET, and may therefore refrain from mapping the configured CORESET to a different CORESET. Stated differently, if an eRedCap UE 115 is configured with a CORESET0 with a size that fits within a maximum bandwidth associated with the eRedCap UE 115, the eRedCap UE 115 may refrain from mapping the configured CORESET and may simply monitor the configured CORESET.

Comparatively, eRedCap UEs 115 may be unable to monitor CORESETs associated with CORESET indices 6 through 14, as such CORESETs span more than the maximum downlink bandwidth that is capable of being monitored by the eRedCap UEs 115. In other words, CORESETs associated with CORESET indices 6-14 may not fit within a 5 MHz sub-band that is capable of being monitored by the eRedCap UE 115. As such, in cases where an eRedCap UE 115 is configured with a CORESET corresponding to any of CORESET indices 6-14, the eRedCap UE 115 may be configured to map the configured CORESET to a new CORESET (e.g., a different CORESET within Table 1) that the eRedCap UE 115 will be able to monitor.

Stated differently, although a SIB1 PDCCH configuration may be identical for eRedCap UEs 115 and other UEs 115, the PDCCH configuration may be interpreted differently by regular RedCap UEs 115 and full-capability UEs 115 as compared to eRedCap UEs 115. In this regard, eRedCap UEs 115 may interpret configured CORESET indices illustrated in Table 1 differently (e.g., according to CORESET mapping configurations or other interpretation rules) as compared to other types/categories of UEs 115.

For example, referring to Table 1 above, an eRedCap UE 115 may receive, from a network entity 105, a control message (e.g., MIB, SIB1) that configures the eRedCap UE 115 to monitor CORESET #10 corresponding to CORESET index 10 that is used by regular RedCap UEs 115 and/or full-capability UEs 115. In this example, the eRedCap UE 115 and the network entity 105 may determine that the configured CORESET (CORESET #10) spans a set of resources that is larger than a maximum downlink BWP that can be monitored by the eRedCap UE 115. Accordingly, the eRedCap UE 115 and the network entity 105 may map CORESET #10 to a different CORESET that the eRedCap UE 115 will be able to monitor (e.g., one of CORESETs #0 through #5). For instance, a first CORESET mapping configuration may cause the eRedCap UE 115 and the network entity 105 to map CORESET #10 from Table 1 to CORESET #3 in Table 1. By way of another example, a second CORESET mapping configuration may cause the eRedCap UE 115 and the network entity 105 to map CORESET #10 from Table 1 to CORESET #5 in Table 1.

In this regard, CORESET mapping configurations may cause eRedCap UEs 115 (and network entities 105 that configure eRedCap UEs 115 with CORESETs) to interpret CORESET indices illustrated in Table 1 differently as compared to other types or categories of UEs 115. In some implementations, CORESET mapping configurations may define simple rules or mappings to map one CORESET index to another (e.g., map CORESET #10 to CORESET #5).

In additional or alternative implementations, CORESET mapping configurations may define rules or conditions used to map CORESET indices based on additional characteristics or parameters. In other words, if a CORESET0 configuration is configured for regular full-capability UEs 115 and reinterpreted by eRedCap UEs 115 (as described herein), the CORESET0 configuration index (first column of Table 1) for eRedCap UEs 115 may be determined based on a number of parameters or characteristics (which may be defined by a CORESET mapping configuration).

Characteristics or parameters that may be used by CORESET mapping configurations to determine which CORESET a eRedCap UE 115 is expected to monitor may include, but are not limited to, the configured CORESET0 configuration index (e.g., first column from Table 1), the maximum number of CORESET0 configurations with sizes fitting into the maximum bandwidth of the respective eRedCap UE 115 (e.g., six CORESET configurations in Table 1 with indices 0-5 may fit within a maximum downlink bandwidth capable of being monitored by an eRedCap UE 115), the number of CORESET symbols (e.g., fourth column of Table 1), the resource block offset value (e.g., the offset between SSB and CORESET0, as shown in the fifth column of Table 1), and the like.

For example, an eRedCap UE 115 may be configured to map CORESETs according to a CORESET mapping configuration defined by K=mod(C, N), where K is the CORESET0 configuration index that is to be monitored by the eRedCap UE 115, C is the configured CORESET0 configuration index (e.g., as indicated by a MIB/SIB1), N is the maximum number of CORESET0 configurations with sizes in the frequency domain that fit within a maximum bandwidth of the eRedCap UE 115, and mod is some mathematical function or formula. In this example, the eRedCap UE 115 may receive a MIB indicating the C value, and may determine N=6 (as CORESET indices 0-5 are less than 5 MHz). As such, the eRedCap UE 115 may determine the CORESET index K that the eRedCap UE 115 is to monitor using the equation defined by the configured CORESET mapping configuration.

FIG. 4 illustrates an example of a process flow 400 that supports CORESET determination for eRedCap UEs in accordance with one or more aspects of the present disclosure. In some examples, aspects of the process flow 400 may implement, or be implemented by, aspects of the wireless communications system 100, the wireless communications system 200, the resource configuration 300, or any combination thereof. In particular, the process flow 400 illustrates techniques that enable UEs 115, such as eRedCap UEs 115, to select a sub-band that will be monitored from a configured CORESET or BWP, as shown and described with reference to the first resource configuration 210-a illustrated in FIG. 2.

The process flow 400 may include a UE 115-c and a network entity 105-b, which may be examples of UEs 115, network entities 105, and other wireless devices described with reference to FIGS. 1-3. For example, the UE 115-c and the network entity 105-b illustrated in FIG. 4 may include examples of the first UE 115-a and the network entity 105-a, respectively, as illustrated in FIG. 2. In this regard, the UE 115-c illustrated in FIG. 4 may be an example of an eRedCap UE 115.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 405, the UE 115-c may receive, from the network entity 105-b, a control message indicating a CORESET, where the CORESET is associated with a downlink BWP spanning a set of sub-bands in the frequency domain. In some implementations, the control message may include a MIB, a SIB (e.g., SIB1), or both. Moreover, in some aspects, the CORESET may include an initial coreset (e.g., CORESET0) and the BWP associated with the CORESET may include an initial downlink BWP, as illustrated in FIG. 2. In some aspects, the CORESET and/or BWP may span a set of resources in the frequency domain that exceeds a maximum bandwidth that the UE 115-c is able to monitor.

At 410, the UE 115-c may receive an SSB from the network entity 105-b. In some aspects, the SSB may indicate information or other configurations usable by the UE 115-c to select a sub-band from the set of sub-bands spanned by the BWP associated with the CORESET. In this regard, in some cases, the UE 115-c may receive the SSB at 410 based on receiving the first control message at 405.

For example, in some cases, the SSB may indicate a PCID associated with the UE 115-c, where the PCID may be used to determine which sub-band the UE 115-c is configured or expected to select. By way of another example, in some aspects, the SSB may indicate a sub-band configuration usable by the UE 115-c for selecting a sub-band from the set of sub-bands spanned by the BWP. In this regard, the SSB may indicate a sub-band configuration including set of rules or conditions that are used to determine which sub-band the UE 115-c is configured (and/or expected) to select from the set of sub-bands spanned by the BWP.

While the first control message at 405 and the SSB at 410 are shown and described as separate messages, this is not to be regarded as a limitation of the present disclosure, unless noted otherwise herein. In particular, in some implementations, the CORESET, the PCID, the sub-band configuration, or any combination thereof, may be indicated to the UE 115-c via the same message (e.g., via a MIB, SIB1, SSB, etc.).

At 415, the UE 115-c, the network entity 105-b, or both, may select a sub-band from the set of sub-bands spanned by the BWP associated with the CORESET. For example, as shown in FIG. 2, the UE 115-c and the network entity 105-b may select which sub-band 225 of the set of sub-bands 225 the UE 115-c is expected to monitor. The UE 115-c and/or the network entity 105-b may select the sub-band at 415 based on receiving/transmitting the first control message at 405, receiving/transmitting the SSB at 410, or both. For example, in some aspects, the UE 115-c and the network entity 105-b may select a sub-band that the UE 115-c is expected to monitor based on the UE 115-c including an eRedCap UE 115-c, and therefore being unable to monitor the full CORESET/BWP configured at 405.

In some aspects, the UE 115-c and the network entity 105-c may select the sub-band from the set of sub-bands based on the PCID associated with the UE 115-c. For example, in some cases, each sub-band of the set of sub-bands spanned by the BWP may be associated with a respective sub-band ID. In this example, the UE 115-c may be configured (and/or expected) to select the sub-band associated with a lowest sub-band ID if the UE 115-c is associated with an odd numbered PCID, and may be configured (and/or expected) to select the sub-band associated with a highest sub-band ID if the UE 115-c is associated with an even numbered PCID (or vice versa).

In additional or alternative implementations, the UE 115-c and/or the network entity 105-b may be configured to select the sub-band from the set of sub-bands at 415 based on the PCID associated with the UE 115-c and based on a quantity of sub-bands included within the set of sub-bands spanned by the BWP. For example, the UE 115-c and/or the network entity 105-b may be configured (and expected) to select the sub-band with the sub-band index that is determined according to sub−band index=mod(PCID, N), where N is the total number of valid sub-bands within the initial downlink BWP 220, PCID is the PCID of the UE 115-c, and mod represents some mathematical function used to determine which sub-band will be selected.

In additional or alternative implementations, the UE 115-c and/or the network entity 105-b may select which of the sub-bands spanned by the BWP will be monitored in accordance with a sub-band configuration. The sub-band configuration may indicate a set of rules or conditions that are used by the network entity 105-b and the UE 115-c to determine which sub-band the UE 115-c is expected to select and monitor. The sub-band configuration may be preconfigured at the UE 115-c, signaled to the UE 115-c (e.g., via the SSB at 410), or both.

For example, a sub-band configuration may specify that the UE 115-c is to select the sub-band with the lowest sub-band ID when the UE 115-c is associated with an odd-numbered PCID, and select the sub-band with the highest sub-band ID when the UE 115-c is associated with an even-numbered PCID (or vice versa). Similarly, the sub-band configuration may indicate a set of rules or conditions usable by the UE 115-c to select one of the sub-bands based on the quantity of sub-bands included within the set of sub-bands spanned by the BWP.

In some implementations, the UE 115-c and the network entity 105-b may utilize the same rules, conditions, or configurations (e.g., the same sub-band configuration) to select/identify which sub-band the UE 115-c will monitor. In this regard, by using the same rules, conditions, and/or configurations to select the sub-band, the UE 115-c and the network entity 105-b may be on the same page with respect to which sub-band will be used to communicate control information to the UE 115-c.

At 420, the UE 115-c may monitor the sub-band that was selected at 415. In this regard, the UE 115-c may monitor the sub-band that spans a portion of the BWP associated with the CORESET in the frequency domain. As such, the UE 115-c may monitor the sub-band at 420 based on receiving the first control message at 405, receiving the SSB at 410, selecting the sub-band at 415, or any combination thereof. In some aspects, the UE 115-c may monitor the selected sub-band for control signaling that schedules the UE 115-c to receive a SIB.

At 425, the UE 115-c may receive a second control message (e.g., DCI message) from the network entity 105-b within the selected sub-band based. In particular, the UE 115-c may receive the second control message at 425 based on monitoring the selected sub-band at 420. In some implementations, the second control message at 425 may schedule the UE 115-c to receive a SIB. For example, the UE 115-c may receive a DCI message that indicates a set of resources usable by the UE 115-c to receive a SIB.

At 430, the UE 115-c may receive a SIB from the network entity 105-b. In particular, the UE 115-c may receive the SIB scheduled by the second control message at 425 (e.g., within the set of resources indicated by the second control message).

FIG. 5 illustrates an example of a process flow 500 that supports CORESET determination for eRedCap UEs in accordance with one or more aspects of the present disclosure. In some examples, aspects of the process flow 500 may implement, or be implemented by, aspects of the wireless communications system 100, the wireless communications system 200, the resource configuration 300, the process flow 400, or any combination thereof. In particular, the process flow 500 illustrates techniques that enable UEs 115, such as eRedCap UEs 115, to map CORESETs associated with full-capability UEs 115 to CORESETs associated with eRedCap UEs 115, as shown and described with reference to the second resource configuration 210-b illustrated in FIG. 2 and the mapping configurations 305 illustrated in FIG. 3.

The process flow 500 may include a UE 115-d and a network entity 105-b, which may be examples of UEs 115, network entities 105, and other wireless devices described with reference to FIGS. 1-4. For example, the UE 115-d and the network entity 105-c illustrated in FIG. 5 may include examples of the first UE 115-a and the network entity 105-a, respectively, as illustrated in FIG. 2. By way of another example, the UE 115-d and the network entity 105-c illustrated in FIG. 5 may include examples of the UE 115-c and the network entity 105-b, respectively, as illustrated in FIG. 4. In this regard, the UE 115-d illustrated in FIG. 5 may be an example of an eRedCap UE 115.

In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 505, the UE 115-d may receive, from the network entity 105-c, a control message indicating a CORESET, where the CORESET is associated with a first set of resources that span a first frequency range. For example, as shown in FIG. 3, the UE 115-d may receive a control message that indicates the first CORESET 310-a. In some implementations, the control message may include a MIB, a SIB (e.g., SIB1), or both. Moreover, in some aspects, the CORESET may include an initial coreset (e.g., CORESET0).

In some aspects, the control message may indicate a CORESET index associated with the indicated CORESET. For example, the control message may indicate a CORESET index value as illustrated in the first column of Table 1 above. For instance, in some cases, the UE 115-c may be configured (e.g., preconfigured with, signaled) with a data object, such as Table 1 above, where the data object indicates a set of candidate CORESET configurations (e.g., candidate PDCCH configurations) and corresponding CORESET indices. In this example, the control message may indicate which of the CORESET configurations from the data object is to be used by the UE 115-d.

At 510, the UE 115-d, the network entity 105-c, or both, may determine whether the first frequency range of the first CORESET exceeds a threshold frequency size. In some aspects, the threshold frequency size may be based on capabilities of the UE 115-d. For example, the threshold frequency size may include the maximum bandwidth that the UE 115-d is able to monitor. In this regard, at 510, the UE 115-d and/or the network entity 105-c may determine whether the UE 115-c is able (e.g., capable) to monitor the first set of resources associated with the first CORESET configured at 505 (e.g., determine whether the first CORESET exceeds the capabilities of the UE 115-d).

In particular, the UE 115-d and the network entity 105-c may determine whether the first frequency range associated with (e.g., spanned by) the first CORESET exceeds a maximum bandwidth that the UE 115-d is able to monitor. If the first frequency range exceeds (e.g., is larger than) the maximum bandwidth that the UE 115-d is able to monitor, the first CORESET may be determined to exceed the capabilities of the UE 115-c. Conversely, if the first frequency range does not exceed (e.g., is less than or equal to) the maximum bandwidth that the UE 115-d is able to monitor, the first CORESET may be determined not to exceed the capabilities of the UE 115-c.

In cases where the first CORESET does not exceed the threshold frequency size (Step 510=NO), meaning that the UE 115-d is capable of monitoring the first CORESET, the process flow 500 may proceed to step 520. Comparatively, in cases where the first CORESET does exceed the threshold frequency size (Step 510=YES), meaning that the UE 115-d is incapable of monitoring the first CORESET, the process flow 500 may proceed to step 515.

At 515, the UE 115-d, the network entity 105-c, or both, may map the first CORESET to a second CORESET. In particular, the UE 115-d and the network entity 105-c may map the first CORESET to the second CORESET that spans a second frequency range that is smaller than the first frequency range associated with the first CORESET. In other words, the UE 115-c and/or the network entity 105-c may map the first CORESET to a different CORESET that is smaller in the frequency range, as shown and described in FIG. 3.

In some aspects, the UE 115-d and/or the network entity 105-c may map the first CORESET to the second CORESET at 515 based on determining that the first frequency range of the first CORESET exceeds the threshold frequency size at 510. Stated differently, the UE 115-d and the network entity 105-c may map the first CORESET to the second CORESET at 515 based on determining that the UE 115-c is unable to monitor the first CORESET. In this regard, the UE 115-d, the network entity 105-c, or both, may perform the mapping at 515 based on receiving/transmitting the control message at 505, performing the analysis/comparison at 510, or both.

In some aspects, the second CORESET may span more symbols in the time domain as compared to the first CORESET. For example, as shown in FIG. 3, the first CORESET 310-a may be mapped to the second CORESET 310-b or the third CORESET 310-c, where the second CORESET 310-b and the third CORESET 310-c span more symbols in the time domain as compared to the first CORESET 310-a.

In some aspects, the UE 115-d, the network entity 105-c, or both, may map the first CORESET to the second CORESET at 515 in accordance with a CORESET mapping configuration. The CORESET mapping configuration may be preconfigured at the UE 115-d, signaled to the UE 115-d (e.g., via the control message at 505), or both. The CORESET mapping configuration may include a set of rules or conditions that are used to determine how to map the first CORESET to a new CORESET that the UE 115-d is able to monitor. For example, in some cases, the control message at 505 may indicate that the UE 115-d is expected to map the first CORESET to a new CORESET in accordance with the first CORESET mapping configuration 305-a or the second CORESET mapping configuration 305-b illustrated in FIG. 3.

Additionally, or alternatively, a CORESET mapping configuration may cause the UE 115-d and/or the network entity 105-c to map or reinterpret CORESET indices shown in Table 1 or some other data object. For example, in cases where the first CORESET is associated with CORESET in index 10 illustrated in Table 1, the CORESET mapping configuration may cause the UE 115-d and the network entity 105-c to map CORESET index 10 to CORESET index 3, where CORESET index 3 is associated with the second CORESET. Stated differently, the UE 115-d and the network entity 105-c may perform the mapping at 515 by referencing and reinterpreting CORESET index values included within some data object, such as Table 1.

In some aspects, the UE 115-d and/or the network entity 105-c may perform the mapping at 515 based on a set of parameters. In other words, the CORESET mapping configuration may include rules or conditions for mapping CORESETs based on certain parameters. Parameters that may be used to perform the CORESET mapping at 515 may include, but are not limited to, a quantity of CORESETs that are capable of being monitored by the UE 115-d, a first quantity of symbols spanned by the first CORESET and/or second CORESET in a time domain, a second quantity of symbols spanned by the first CORESET and/or second CORESET in the time domain, a resource block offset value, or any combination thereof.

At 520, the UE 115-d may monitor one of the first CORESET or the second CORESET. In particular, the UE 115-d may monitor one of the first CORESET or the second CORESET based on the result of the comparison performed at 510.

For example, in cases where the first CORESET does not exceed the threshold frequency size (Step 510=NO), e.g., meaning that the UE 115-d is capable of monitoring the first CORESET, the UE 115-d may monitor the first CORESET at 520. Conversely, in cases where the first CORESET does exceed the threshold frequency size (Step 510=YES), e.g., meaning that the UE 115-d is incapable of monitoring the first CORESET, the UE 115-d may perform the mapping at 515 and therefore monitor the second CORESET at 520. In this regard, the UE 115-d may monitor one of the first CORESET or the second CORESET based on receiving the control message at 505, performing the analysis/comparison at 510, mapping the first CORESET to the second CORESET at 515, or any combination thereof. In some aspects, the UE 115-d may monitor the first CORESET at 520 for control signaling that schedules the UE 115-d to receive a SIB.

At 525, the UE 115-d may receive a second control message (e.g., DCI message) from the network entity 105-c within the respective CORESET. In particular, the UE 115-d may receive the second control message at 525 within the respective CORESET that was monitored at 520. In some implementations, the second control message at 525 may schedule the UE 115-d to receive a SIB. For example, the UE 115-d may receive a DCI message that indicates a set of resources usable by the UE 115-d to receive a SIB.

At 530, the UE 115-d may receive a SIB from the network entity 105-c. In particular, the UE 115-d may receive the SIB scheduled by the second control message at 525 (e.g., within the set of resources indicated by the second control message).

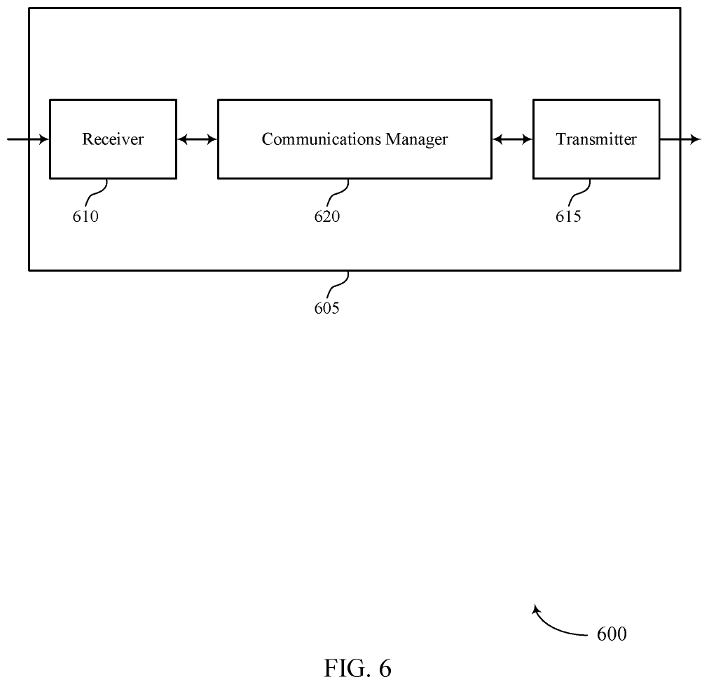

FIG. 6 shows a block diagram 600 of a device 605 that supports CORESET determination for eRedCap UEs in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to CORESET determination for eRedCap UEs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to CORESET determination for eRedCap UEs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of CORESET determination for eRedCap UEs as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving, from a network entity, a control message indicating a CORESET, where the CORESET is associated with a downlink BWP spanning a set of multiple sub-bands in a frequency domain. The communications manager 620 may be configured as or otherwise support a means for selecting a sub-band of the set of multiple sub-bands based on a PCID associated with the UE. The communications manager 620 may be configured as or otherwise support a means for monitoring the selected sub-band for control signaling that schedules the UE to receive a SIB. The communications manager 620 may be configured as or otherwise support a means for receiving a second control message from the network entity within the selected sub-band based on monitoring the selected sub-band, the second control message scheduling the UE to receive the SIB.

Additionally, or alternatively, the communications manager 620 may support wireless communication at a UE in accordance with examples as disclosed herein. For example, the communications manager 620 may be configured as or otherwise support a means for receiving, from a network entity, a control message indicating a CORESET associated with a first set of resources that span a first frequency range. The communications manager 620 may be configured as or otherwise support a means for mapping the CORESET to an additional CORESET associated with a second set of resources that span a second frequency range that is smaller than the first frequency range based on the first frequency range exceeding a threshold frequency size. The communications manager 620 may be configured as or otherwise support a means for monitoring, based on the mapping, the additional CORESET for control signaling that schedules the UE to receive a SIB. The communications manager 620 may be configured as or otherwise support a means for receiving a second control message from the network entity within the additional CORESET based on monitoring the additional CORESET, the second control message scheduling the UE to receive the SIB.

By including or configuring the communications manager 620 in accordance with examples as described herein, the device 605 (e.g., a processor controlling or otherwise coupled with the receiver 610, the transmitter 615, the communications manager 620, or a combination thereof) may support techniques that enable RedCap UEs 115 to be configured with CORESETs and/or BWPs capable of being monitored by regular, full-capability UEs 115 and identify CORESETs/BWPs that are capable of being monitored by RedCap UEs 115. As such, aspects of the present disclosure may enable traditional control signaling used to configure CORESETs/BWPs for regular-capacity UEs 115 to be used to configure CORESETs/BWPs for RedCap UEs 115, such as eRedCap UEs 115. As such, techniques described herein may reduce control signaling used to configure CORESETs and BWPs for regular, full-capability UEs 115 and RedCap UEs 115. Moreover, aspects of the present disclosure provide for rules, conditions, and configurations for selecting/identifying resources that will be monitored by RedCap UEs 115 so that the RedCap UEs 115 and the network can be on the same page with respect to which resources will be used to communicate control signaling to the RedCap UEs 115. As such, techniques described herein may improve an efficiency and reliability of wireless communications between RedCap UEs 115 and the network.

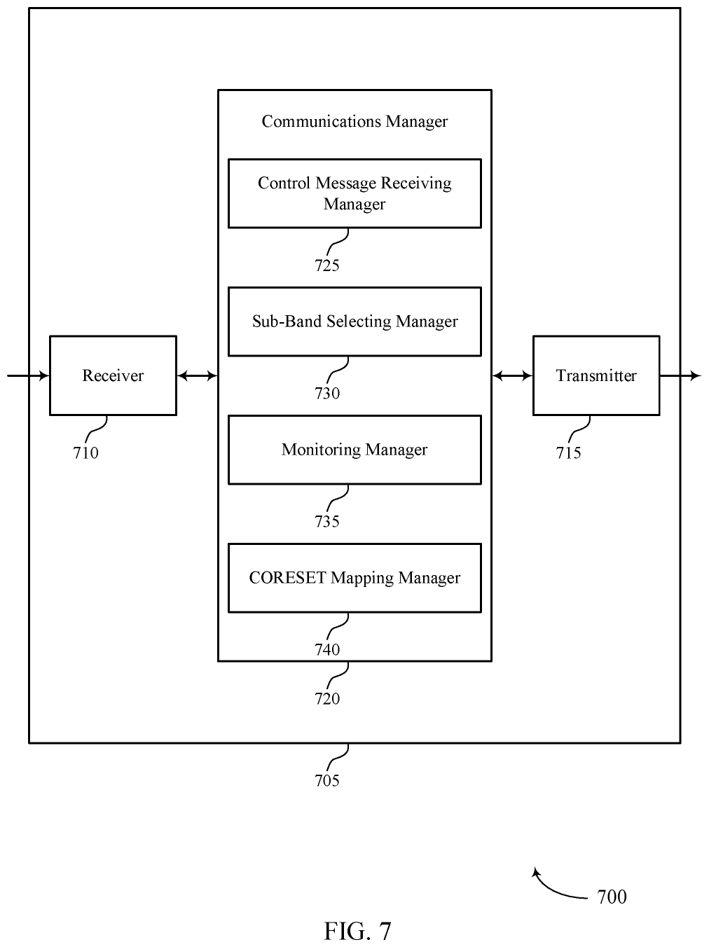

FIG. 7 shows a block diagram 700 of a device 705 that supports CORESET determination for eRedCap UEs in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to CORESET determination for eRedCap UEs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to CORESET determination for eRedCap UEs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of CORESET determination for eRedCap UEs as described herein. For example, the communications manager 720 may include a control message receiving manager 725, a sub-band selecting manager 730, a monitoring manager 735, a CORESET mapping manager 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The control message receiving manager 725 may be configured as or otherwise support a means for receiving, from a network entity, a control message indicating a CORESET, where the CORESET is associated with a downlink BWP spanning a set of multiple sub-bands in a frequency domain. The sub-band selecting manager 730 may be configured as or otherwise support a means for selecting a sub-band of the set of multiple sub-bands based on a PCID associated with the UE. The monitoring manager 735 may be configured as or otherwise support a means for monitoring the selected sub-band for control signaling that schedules the UE to receive a SIB. The control message receiving manager 725 may be configured as or otherwise support a means for receiving a second control message from the network entity within the selected sub-band based on monitoring the selected sub-band, the second control message scheduling the UE to receive the SIB.

Additionally, or alternatively, the communications manager 720 may support wireless communication at a UE in accordance with examples as disclosed herein. The control message receiving manager 725 may be configured as or otherwise support a means for receiving, from a network entity, a control message indicating a CORESET associated with a first set of resources that span a first frequency range. The CORESET mapping manager 740 may be configured as or otherwise support a means for mapping the CORESET to an additional CORESET associated with a second set of resources that span a second frequency range that is smaller than the first frequency range based on the first frequency range exceeding a threshold frequency size. The monitoring manager 735 may be configured as or otherwise support a means for monitoring, based on the mapping, the additional CORESET for control signaling that schedules the UE to receive a SIB. The control message receiving manager 725 may be configured as or otherwise support a means for receiving a second control message from the network entity within the additional CORESET based on monitoring the additional CORESET, the second control message scheduling the UE to receive the SIB.

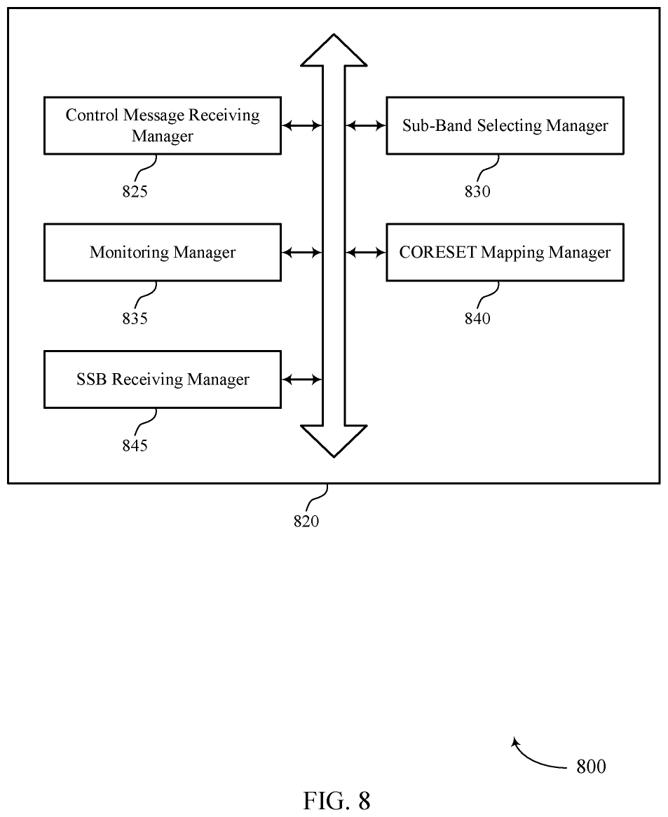

FIG. 8 shows a block diagram 800 of a communications manager 820 that supports CORESET determination for eRedCap UEs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of CORESET determination for eRedCap UEs as described herein. For example, the communications manager 820 may include a control message receiving manager 825, a sub-band selecting manager 830, a monitoring manager 835, a CORESET mapping manager 840, an SSB receiving manager 845, or any combination thereof. Each of these components may communicate, directly or indirectly, with one another (e.g., via one or more buses).

The communications manager 820 may support wireless communication at a UE in accordance with examples as disclosed herein. The control message receiving manager 825 may be configured as or otherwise support a means for receiving, from a network entity, a control message indicating a CORESET, where the CORESET is associated with a downlink BWP spanning a set of multiple sub-bands in a frequency domain. The sub-band selecting manager 830 may be configured as or otherwise support a means for selecting a sub-band of the set of multiple sub-bands based on a PCID associated with the UE. The monitoring manager 835 may be configured as or otherwise support a means for monitoring the selected sub-band for control signaling that schedules the UE to receive a SIB. In some examples, the control message receiving manager 825 may be configured as or otherwise support a means for receiving a second control message from the network entity within the selected sub-band based on monitoring the selected sub-band, the second control message scheduling the UE to receive the SIB.

In some examples, each sub-band of the set of multiple sub-bands is associated with a respective sub-band ID, and the sub-band selecting manager 830 may be configured as or otherwise support a means for selecting the sub-band associated with a lowest sub-band ID from the set of multiple sub-bands based on the PCID including an odd numbered PCID. In some examples, each sub-band of the set of multiple sub-bands is associated with a respective sub-band ID, and the sub-band selecting manager 830 may be configured as or otherwise support a means for selecting the sub-band associated with a highest sub-band ID from the set of multiple sub-bands based on the PCID including an even numbered PCID.

In some examples, the sub-band selecting manager 830 may be configured as or otherwise support a means for selecting the sub-band based on a quantity of sub-bands included within the set of multiple sub-bands and based on the PCID.

In some examples, the SSB receiving manager 845 may be configured as or otherwise support a means for receiving, from the network entity, an SSB indicating the PCID, where selecting the sub-band is based on receiving the SSB.

In some examples, the SSB receiving manager 845 may be configured as or otherwise support a means for receiving, from the network entity, an SSB indicating a sub-band configuration usable by the UE for selecting the sub-band from the set of multiple sub-bands, where the sub-band is selected from the set of multiple sub-bands in accordance with the sub-band configuration.

In some examples, the control message includes a MIB. In some examples, selecting the sub-band of the set of multiple sub-bands is based on the UE including an eRedCap UE.

Additionally, or alternatively, the communications manager 820 may support wireless communication at a UE in accordance with examples as disclosed herein. In some examples, the control message receiving manager 825 may be configured as or otherwise support a means for receiving, from a network entity, a control message indicating a CORESET associated with a first set of resources that span a first frequency range. The CORESET mapping manager 840 may be configured as or otherwise support a means for mapping the CORESET to an additional CORESET associated with a second set of resources that span a second frequency range that is smaller than the first frequency range based on the first frequency range exceeding a threshold frequency size. In some examples, the monitoring manager 835 may be configured as or otherwise support a means for monitoring, based on the mapping, the additional CORESET for control signaling that schedules the UE to receive a SIB. In some examples, the control message receiving manager 825 may be configured as or otherwise support a means for receiving a second control message from the network entity within the additional CORESET based on monitoring the additional CORESET, the second control message scheduling the UE to receive the SIB.

In some examples, the CORESET mapping manager 840 may be configured as or otherwise support a means for receiving a CORESET mapping configuration for mapping CORESETs, where the first CORESET is mapped to the second CORESET in accordance with the CORESET mapping configuration.

In some examples, the first set of resources associated with the CORESET spans a first set of symbols in a time domain. In some examples, the second set of resources associated with the additional CORESET spans a second set of symbols in the time domain that is greater than the first set of symbols.

In some examples, the control message receiving manager 825 may be configured as or otherwise support a means for receiving, via the control message, a first CORESET index associated with the CORESET. In some examples, the CORESET mapping manager 840 may be configured as or otherwise support a means for mapping the first CORESET index to a second CORESET index associated with the additional CORESET.

In some examples, the CORESET mapping manager 840 may be configured as or otherwise support a means for receiving a data object including a set of multiple CORESET indices corresponding to a set of multiple CORESET indices, where mapping the first CORESET index to the second CORESET index is based on referencing the data object.

In some examples, mapping the CORESET to the additional CORESET is based on a set of parameters. In some examples, the set of parameters include a quantity of CORESETs that are capable of being monitored by the UE, a first quantity of symbols spanned by the CORESET in a time domain, a second quantity of symbols spanned by the additional CORESET in the time domain, a resource block offset value, or any combination thereof.

In some examples, the control message receiving manager 825 may be configured as or otherwise support a means for receiving, from the network entity, a third control message indicating a third CORESET associated with a third set of resources that span a third frequency range. In some examples, the monitoring manager 835 may be configured as or otherwise support a means for monitoring the third CORESET for additional control signaling based on the third frequency range failing to satisfy a threshold frequency range associated with the UE. In some examples, the control message receiving manager 825 may be configured as or otherwise support a means for receiving a fourth control message from the network entity within the third CORESET based on monitoring the third CORESET. In some examples, the control message includes a MIB.

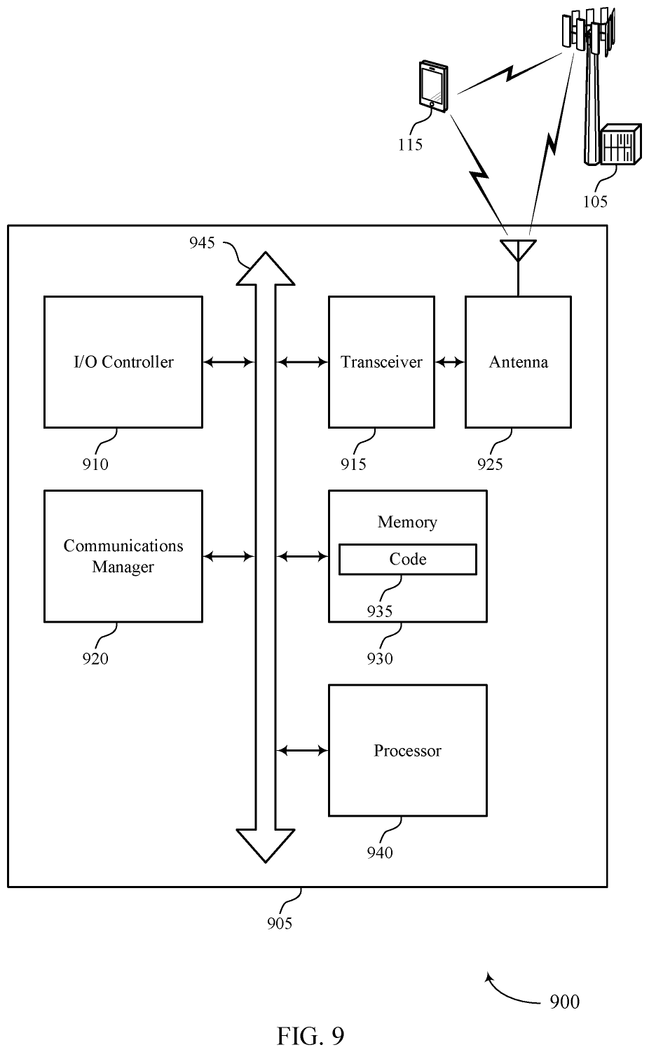

FIG. 9 shows a diagram of a system 900 including a device 905 that supports CORESET determination for eRedCap UEs in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting CORESET determination for eRedCap UEs). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, from a network entity, a control message indicating a CORESET, where the CORESET is associated with a downlink BWP spanning a set of multiple sub-bands in a frequency domain. The communications manager 920 may be configured as or otherwise support a means for selecting a sub-band of the set of multiple sub-bands based on a PCID associated with the UE. The communications manager 920 may be configured as or otherwise support a means for monitoring the selected sub-band for control signaling that schedules the UE to receive a SIB. The communications manager 920 may be configured as or otherwise support a means for receiving a second control message from the network entity within the selected sub-band based on monitoring the selected sub-band, the second control message scheduling the UE to receive the SIB.

Additionally, or alternatively, the communications manager 920 may support wireless communication at a UE in accordance with examples as disclosed herein. For example, the communications manager 920 may be configured as or otherwise support a means for receiving, from a network entity, a control message indicating a CORESET associated with a first set of resources that span a first frequency range. The communications manager 920 may be configured as or otherwise support a means for mapping the CORESET to an additional CORESET associated with a second set of resources that span a second frequency range that is smaller than the first frequency range based on the first frequency range exceeding a threshold frequency size. The communications manager 920 may be configured as or otherwise support a means for monitoring, based on the mapping, the additional CORESET for control signaling that schedules the UE to receive a SIB. The communications manager 920 may be configured as or otherwise support a means for receiving a second control message from the network entity within the additional CORESET based on monitoring the additional CORESET, the second control message scheduling the UE to receive the SIB.

By including or configuring the communications manager 920 in accordance with examples as described herein, the device 905 may support techniques that enable RedCap UEs 115 to be configured with CORESETs and/or BWPs capable of being monitored by regular, full-capability UEs 115 and identify CORESETs/BWPs that are capable of being monitored by RedCap UEs 115. As such, aspects of the present disclosure may enable traditional control signaling used to configure CORESETs/BWPs for regular-capacity UEs 115 to be used to configure CORESETs/BWPs for RedCap UEs 115, such as eRedCap UEs 115. As such, techniques described herein may reduce control signaling used to configure CORESETs and BWPs for regular, full-capability UEs 115 and RedCap UEs 115. Moreover, aspects of the present disclosure provide for rules, conditions, and configurations for selecting/identifying resources that will be monitored by RedCap UEs 115 so that the RedCap UEs 115 and the network can be on the same page with respect to which resources will be used to communicate control signaling to the RedCap UEs 115. As such, techniques described herein may improve an efficiency and reliability of wireless communications between RedCap UEs 115 and the network.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of CORESET determination for eRedCap UEs as described herein, or the processor 940 and the memory 930 may be otherwise configured to perform or support such operations.

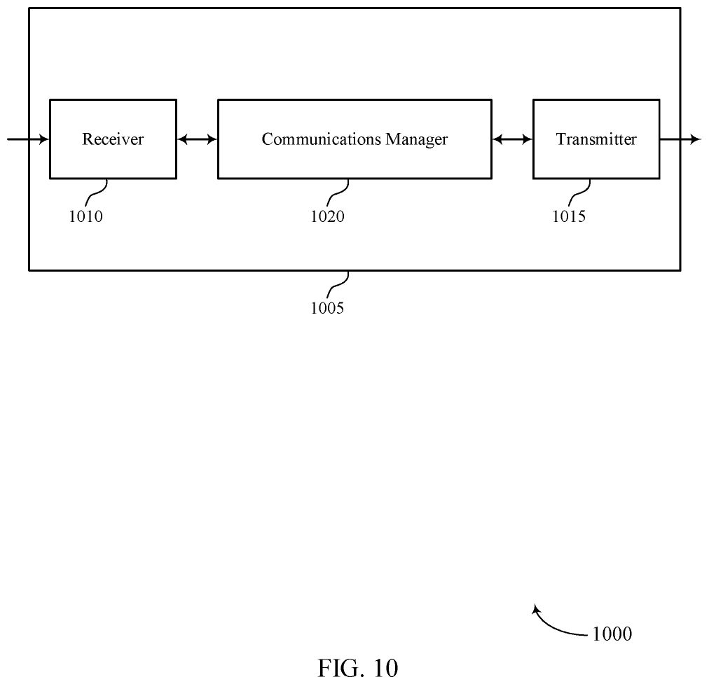

FIG. 10 shows a block diagram 1000 of a device 1005 that supports CORESET determination for eRedCap UEs in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of CORESET determination for eRedCap UEs as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at network entity in accordance with examples as disclosed herein. For example, the communications manager 1020 may be configured as or otherwise support a means for transmitting, to a UE, a control message indicating a CORESET, where the CORESET is associated with a downlink BWP spanning a set of multiple sub-bands in a frequency domain. The communications manager 1020 may be configured as or otherwise support a means for identifying a sub-band of the set of multiple sub-bands of the downlink BWP associated with the CORESET based on a PCID associated with the UE. The communications manager 1020 may be configured as or otherwise support a means for transmitting a second control message to the UE within the identified sub-band, the second control message scheduling the UE to receive a SIB.

Additionally, or alternatively, the communications manager 1020 may support wireless communication at a network entity in accordance with examples as disclosed herein. For example, the communications manager 1020 may be configured as or otherwise support a means for transmitting, to a UE, a control message indicating a CORESET associated with a first set of resources that span a first frequency range. The communications manager 1020 may be configured as or otherwise support a means for mapping the CORESET to an additional CORESET associated with a second set of resources that span a second frequency range that is smaller than the first frequency range based on the first frequency range exceeding a threshold frequency size. The communications manager 1020 may be configured as or otherwise support a means for transmitting a second control message to the UE within the additional CORESET based on the mapping, the second control message scheduling the UE to receive a SIB.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques that enable RedCap UEs 115 to be configured with CORESETs and/or BWPs capable of being monitored by regular, full-capability UEs 115 and identify CORESETs/BWPs that are capable of being monitored by RedCap UEs 115. As such, aspects of the present disclosure may enable traditional control signaling used to configure CORESETs/BWPs for regular-capacity UEs 115 to be used to configure CORESETs/BWPs for RedCap UEs 115, such as eRedCap UEs 115. As such, techniques described herein may reduce control signaling used to configure CORESETs and BWPs for regular, full-capability UEs 115 and RedCap UEs 115. Moreover, aspects of the present disclosure provide for rules, conditions, and configurations for selecting/identifying resources that will be monitored by RedCap UEs 115 so that the RedCap UEs 115 and the network can be on the same page with respect to which resources will be used to communicate control signaling to the RedCap UEs 115. As such, techniques described herein may improve an efficiency and reliability of wireless communications between RedCap UEs 115 and the network.

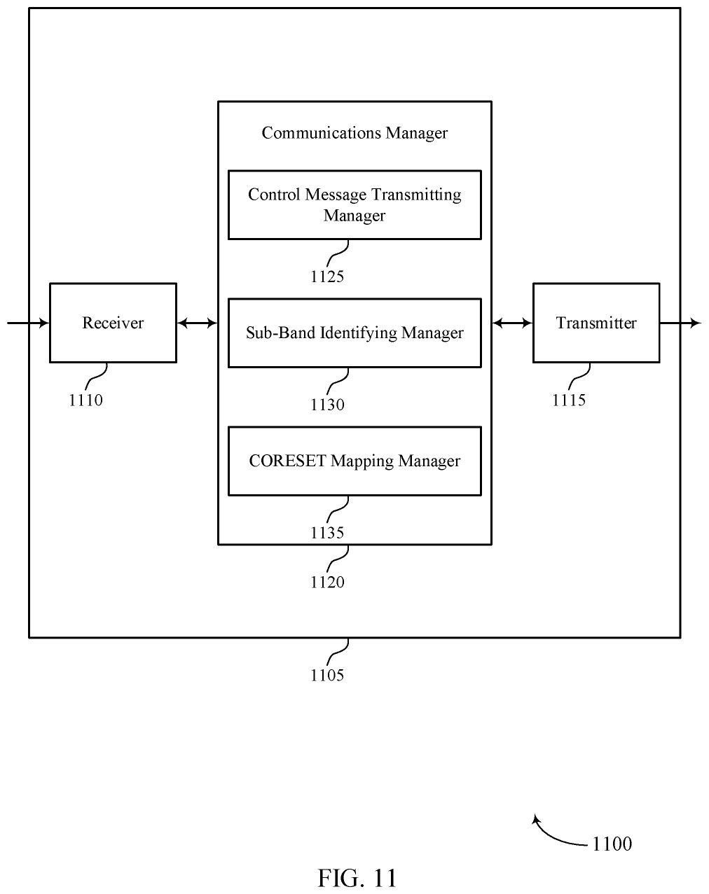

FIG. 11 shows a block diagram 1100 of a device 1105 that supports CORESET determination for eRedCap UEs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of CORESET determination for eRedCap UEs as described herein. For example, the communications manager 1120 may include a control message transmitting manager 1125, a sub-band identifying manager 1130, a CORESET mapping manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at network entity in accordance with examples as disclosed herein. The control message transmitting manager 1125 may be configured as or otherwise support a means for transmitting, to a UE, a control message indicating a CORESET, where the CORESET is associated with a downlink BWP spanning a set of multiple sub-bands in a frequency domain. The sub-band identifying manager 1130 may be configured as or otherwise support a means for identifying a sub-band of the set of multiple sub-bands of the downlink BWP associated with the CORESET based on a PCID associated with the UE. The control message transmitting manager 1125 may be configured as or otherwise support a means for transmitting a second control message to the UE within the identified sub-band, the second control message scheduling the UE to receive a SIB.

Additionally, or alternatively, the communications manager 1120 may support wireless communication at a network entity in accordance with examples as disclosed herein. The control message transmitting manager 1125 may be configured as or otherwise support a means for transmitting, to a UE, a control message indicating a CORESET associated with a first set of resources that span a first frequency range. The CORESET mapping manager 1135 may be configured as or otherwise support a means for mapping the CORESET to an additional CORESET associated with a second set of resources that span a second frequency range that is smaller than the first frequency range based on the first frequency range exceeding a threshold frequency size. The control message transmitting manager 1125 may be configured as or otherwise support a means for transmitting a second control message to the UE within the additional CORESET based on the mapping, the second control message scheduling the UE to receive a SIB.

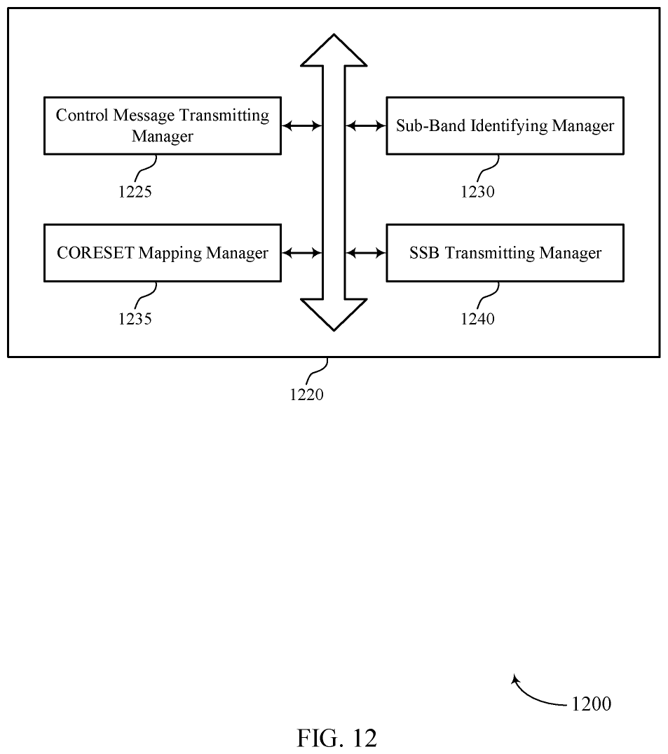

FIG. 12 shows a block diagram 1200 of a communications manager 1220 that supports CORESET determination for eRedCap UEs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of CORESET determination for eRedCap UEs as described herein. For example, the communications manager 1220 may include a control message transmitting manager 1225, a sub-band identifying manager 1230, a CORESET mapping manager 1235, an SSB transmitting manager 1240, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at network entity in accordance with examples as disclosed herein. The control message transmitting manager 1225 may be configured as or otherwise support a means for transmitting, to a UE, a control message indicating a CORESET, where the CORESET is associated with a downlink BWP spanning a set of multiple sub-bands in a frequency domain. The sub-band identifying manager 1230 may be configured as or otherwise support a means for identifying a sub-band of the set of multiple sub-bands of the downlink BWP associated with the CORESET based on a PCID associated with the UE. In some examples, the control message transmitting manager 1225 may be configured as or otherwise support a means for transmitting a second control message to the UE within the identified sub-band, the second control message scheduling the UE to receive a SIB.

In some examples, each sub-band of the set of multiple sub-bands is associated with a respective sub-band ID, and the sub-band identifying manager 1230 may be configured as or otherwise support a means for identifying the sub-band associated with a lowest sub-band ID from the set of multiple sub-bands based on the PCID including an odd numbered PCID. In some examples, each sub-band of the set of multiple sub-bands is associated with a respective sub-band ID, and the sub-band identifying manager 1230 may be configured as or otherwise support a means for identifying the sub-band associated with a highest sub-band ID from the set of multiple sub-bands based on the PCID including an even numbered PCID.

In some examples, the sub-band identifying manager 1230 may be configured as or otherwise support a means for identifying the sub-band based on a quantity of sub-bands included within the set of multiple sub-bands.

In some examples, the SSB transmitting manager 1240 may be configured as or otherwise support a means for transmitting, to the UE, an SSB indicating the PCID, where identifying the sub-band, transmitting the second control message, or both, is based on transmitting the SSB.

In some examples, the SSB transmitting manager 1240 may be configured as or otherwise support a means for transmitting, to the UE, an SSB indicating a sub-band configuration usable by the UE for selecting the sub-band from the set of multiple sub-bands, where the sub-band is identified from the set of multiple sub-bands in accordance with the sub-band configuration.

In some examples, the control message includes a MIB. In some examples, identifying the sub-band from the set of multiple sub-bands is based on the UE including an eRedCap UE.

Additionally, or alternatively, the communications manager 1220 may support wireless communication at a network entity in accordance with examples as disclosed herein. In some examples, the control message transmitting manager 1225 may be configured as or otherwise support a means for transmitting, to a UE, a control message indicating a CORESET associated with a first set of resources that span a first frequency range. The CORESET mapping manager 1235 may be configured as or otherwise support a means for mapping the CORESET to an additional CORESET associated with a second set of resources that span a second frequency range that is smaller than the first frequency range based on the first frequency range exceeding a threshold frequency size. In some examples, the control message transmitting manager 1225 may be configured as or otherwise support a means for transmitting a second control message to the UE within the additional CORESET based on the mapping, the second control message scheduling the UE to receive a SIB.

In some examples, the CORESET mapping manager 1235 may be configured as or otherwise support a means for transmitting a CORESET mapping configuration for mapping CORESETs, where the first CORESET is mapped to the second CORESET in accordance with the CORESET mapping configuration.

In some examples, the first set of resources associated with the CORESET spans a first set of symbols in a time domain. In some examples, the second set of resources associated with the additional CORESET spans a second set of symbols in the time domain that is greater than the first set of symbols.

In some examples, the control message transmitting manager 1225 may be configured as or otherwise support a means for transmitting, via the control message, a first CORESET index associated with the CORESET. In some examples, the CORESET mapping manager 1235 may be configured as or otherwise support a means for mapping the first CORESET index to a second CORESET index associated with the additional CORESET.

In some examples, the CORESET mapping manager 1235 may be configured as or otherwise support a means for transmitting, to the UE, a data object including a set of multiple CORESET indices corresponding to a set of multiple CORESET indices, where mapping the first CORESET index to the second CORESET index is based on referencing the data object.

In some examples, mapping the CORESET to the additional CORESET is based on a set of parameters. In some examples, the set of parameters include a quantity of CORESETs that are capable of being monitored by the UE, a first quantity of symbols spanned by the CORESET in a time domain, a second quantity of symbols spanned by the additional CORESET in the time domain, a resource block offset value, or any combination thereof.

In some examples, the control message transmitting manager 1225 may be configured as or otherwise support a means for transmitting, to the UE, a third control message indicating a third CORESET associated with a third set of resources that span a third frequency range. In some examples, the control message transmitting manager 1225 may be configured as or otherwise support a means for transmitting a fourth control message to the UE within the third CORESET based on the third frequency range failing to satisfy a threshold frequency range associated with the UE. In some examples, the control message includes a MIB.

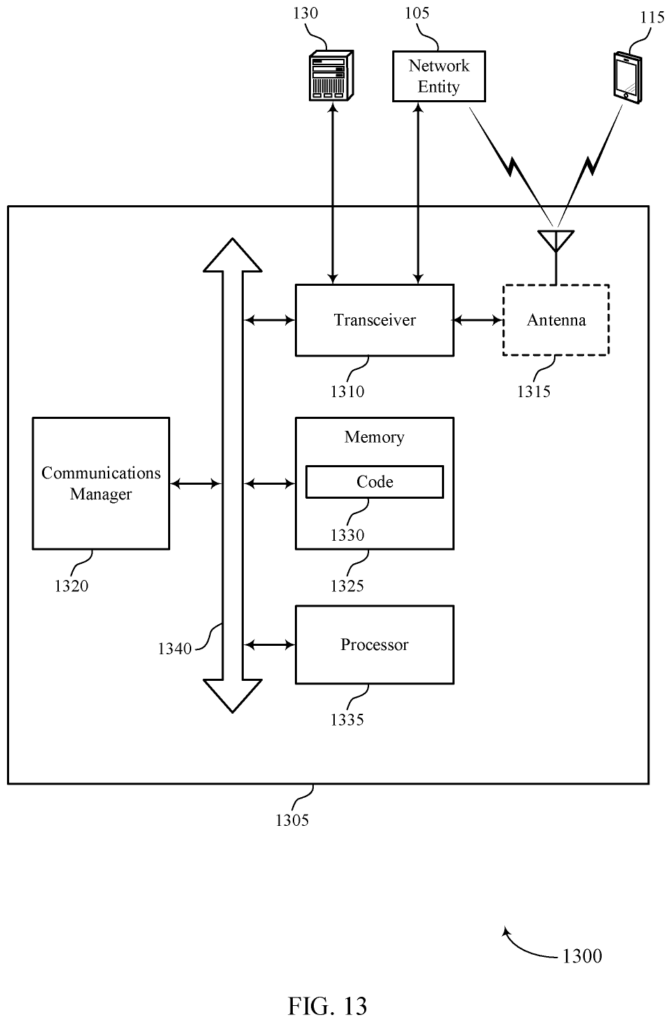

FIG. 13 shows a diagram of a system 1300 including a device 1305 that supports CORESET determination for eRedCap UEs in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting CORESET determination for eRedCap UEs). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at network entity in accordance with examples as disclosed herein. For example, the communications manager 1320 may be configured as or otherwise support a means for transmitting, to a UE, a control message indicating a CORESET, where the CORESET is associated with a downlink BWP spanning a set of multiple sub-bands in a frequency domain. The communications manager 1320 may be configured as or otherwise support a means for identifying a sub-band of the set of multiple sub-bands of the downlink BWP associated with the CORESET based on a PCID associated with the UE. The communications manager 1320 may be configured as or otherwise support a means for transmitting a second control message to the UE within the identified sub-band, the second control message scheduling the UE to receive a SIB.

Additionally, or alternatively, the communications manager 1320 may support wireless communication at a network entity in accordance with examples as disclosed herein. For example, the communications manager 1320 may be configured as or otherwise support a means for transmitting, to a UE, a control message indicating a CORESET associated with a first set of resources that span a first frequency range. The communications manager 1320 may be configured as or otherwise support a means for mapping the CORESET to an additional CORESET associated with a second set of resources that span a second frequency range that is smaller than the first frequency range based on the first frequency range exceeding a threshold frequency size. The communications manager 1320 may be configured as or otherwise support a means for transmitting a second control message to the UE within the additional CORESET based on the mapping, the second control message scheduling the UE to receive a SIB.

By including or configuring the communications manager 1320 in accordance with examples as described herein, the device 1305 may support techniques that enable RedCap UEs 115 to be configured with CORESETs and/or BWPs capable of being monitored by regular, full-capability UEs 115 and identify CORESETs/BWPs that are capable of being monitored by RedCap UEs 115. As such, aspects of the present disclosure may enable traditional control signaling used to configure CORESETs/BWPs for regular-capacity UEs 115 to be used to configure CORESETs/BWPs for RedCap UEs 115, such as eRedCap UEs 115. As such, techniques described herein may reduce control signaling used to configure CORESETs and BWPs for regular, full-capability UEs 115 and RedCap UEs 115. Moreover, aspects of the present disclosure provide for rules, conditions, and configurations for selecting/identifying resources that will be monitored by RedCap UEs 115 so that the RedCap UEs 115 and the network can be on the same page with respect to which resources will be used to communicate control signaling to the RedCap UEs 115. As such, techniques described herein may improve an efficiency and reliability of wireless communications between RedCap UEs 115 and the network.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of CORESET determination for eRedCap UEs as described herein, or the processor 1335 and the memory 1325 may be otherwise configured to perform or support such operations.

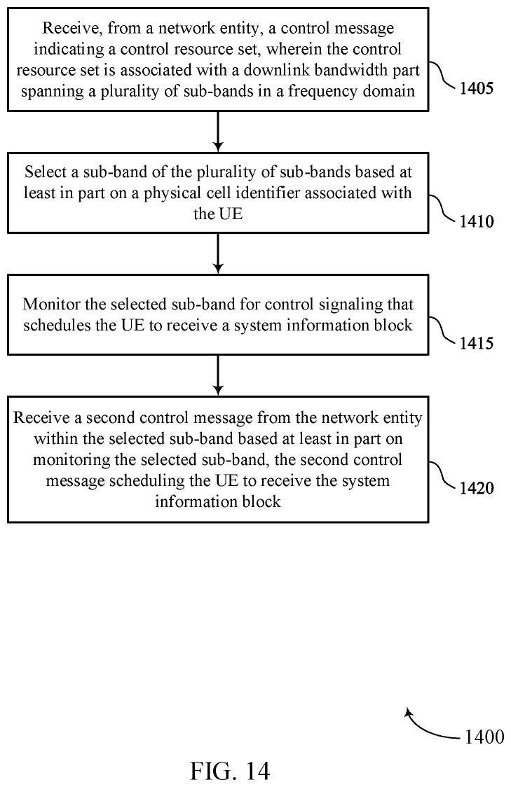

FIG. 14 shows a flowchart illustrating a method 1400 that supports CORESET determination for eRedCap UEs in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a control message indicating a CORESET, where the CORESET is associated with a downlink BWP spanning a set of multiple sub-bands in a frequency domain. The operations of 1405 may be performed in accordance with examples as disclosed herein. In some examples, aspects of the operations of 1405 may be performed by a control message receiving manager 825 as described with reference to FIG. 8.

At 1410, the method may include selecting a sub-band of the set of multiple sub-bands based at least in part on a PCID associated with the UE. The operations of 1410 may be performed in accordance with examples as disclosed herein. In some examples, aspects of the operations of 1410 may be performed by a sub-band selecting manager 830 as described with reference to FIG. 8.

At 1415, the method may include monitoring the selected sub-band for control signaling that schedules the UE to receive a SIB. The operations of 1415 may be performed in accordance with examples as disclosed herein. In some examples, aspects of the operations of 1415 may be performed by a monitoring manager 835 as described with reference to FIG. 8.

At 1420, the method may include receiving a second control message from the network entity within the selected sub-band based at least in part on monitoring the selected sub-band, the second control message scheduling the UE to receive the SIB. The operations of 1420 may be performed in accordance with examples as disclosed herein. In some examples, aspects of the operations of 1420 may be performed by a control message receiving manager 825 as described with reference to FIG. 8.

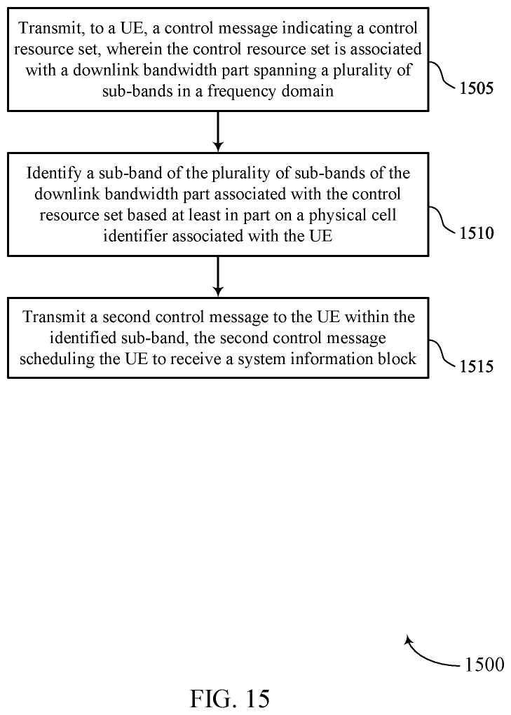

FIG. 15 shows a flowchart illustrating a method 1500 that supports CORESET determination for eRedCap UEs in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE, a control message indicating a CORESET, where the CORESET is associated with a downlink BWP spanning a set of multiple sub-bands in a frequency domain. The operations of 1505 may be performed in accordance with examples as disclosed herein. In some examples, aspects of the operations of 1505 may be performed by a control message transmitting manager 1225 as described with reference to FIG. 12.

At 1510, the method may include identifying a sub-band of the set of multiple sub-bands of the downlink BWP associated with the CORESET based at least in part on a PCID associated with the UE. The operations of 1510 may be performed in accordance with examples as disclosed herein. In some examples, aspects of the operations of 1510 may be performed by a sub-band identifying manager 1230 as described with reference to FIG. 12.

At 1515, the method may include transmitting a second control message to the UE within the identified sub-band, the second control message scheduling the UE to receive a SIB. The operations of 1515 may be performed in accordance with examples as disclosed herein. In some examples, aspects of the operations of 1515 may be performed by a control message transmitting manager 1225 as described with reference to FIG. 12.

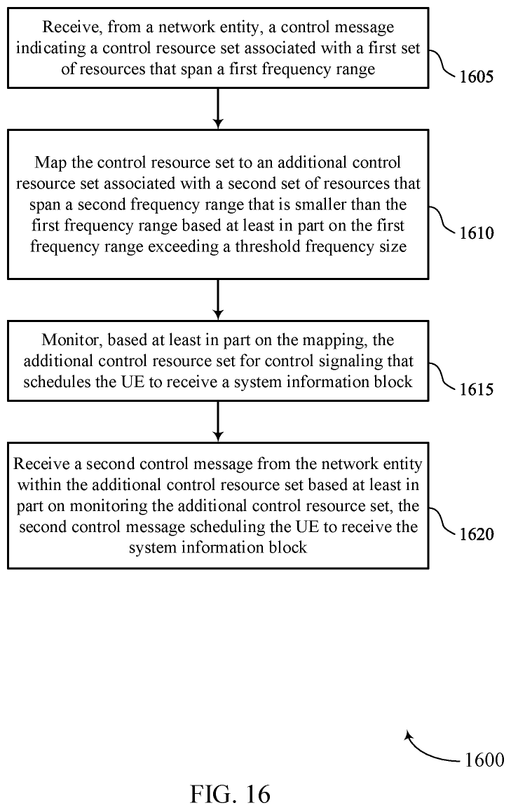

FIG. 16 shows a flowchart illustrating a method 1600 that supports CORESET determination for eRedCap UEs in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, a control message indicating a CORESET associated with a first set of resources that span a first frequency range. The operations of 1605 may be performed in accordance with examples as disclosed herein. In some examples, aspects of the operations of 1605 may be performed by a control message receiving manager 825 as described with reference to FIG. 8.

At 1610, the method may include mapping the CORESET to an additional CORESET associated with a second set of resources that span a second frequency range that is smaller than the first frequency range based at least in part on the first frequency range exceeding a threshold frequency size. The operations of 1610 may be performed in accordance with examples as disclosed herein. In some examples, aspects of the operations of 1610 may be performed by a CORESET mapping manager 840 as described with reference to FIG. 8.

At 1615, the method may include monitoring, based on the mapping, the additional CORESET for control signaling that schedules the UE to receive a SIB. The operations of 1615 may be performed in accordance with examples as disclosed herein. In some examples, aspects of the operations of 1615 may be performed by a monitoring manager 835 as described with reference to FIG. 8.

At 1620, the method may include receiving a second control message from the network entity within the additional CORESET based at least in part on monitoring the additional CORESET, the second control message scheduling the UE to receive the SIB. The operations of 1620 may be performed in accordance with examples as disclosed herein. In some examples, aspects of the operations of 1620 may be performed by a control message receiving manager 825 as described with reference to FIG. 8.

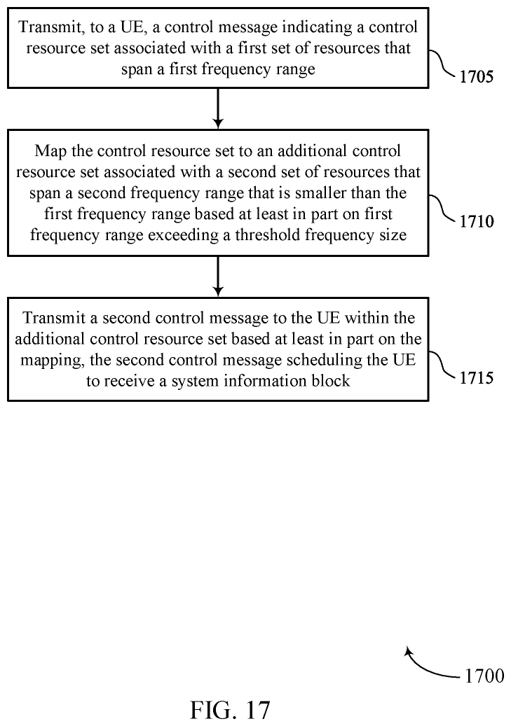

FIG. 17 shows a flowchart illustrating a method 1700 that supports CORESET determination for eRedCap UEs in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, a control message indicating a CORESET associated with a first set of resources that span a first frequency range. The operations of 1705 may be performed in accordance with examples as disclosed herein. In some examples, aspects of the operations of 1705 may be performed by a control message transmitting manager 1225 as described with reference to FIG. 12.

At 1710, the method may include mapping the CORESET to an additional CORESET associated with a second set of resources that span a second frequency range that is smaller than the first frequency range based at least in part on the first frequency range exceeding a threshold frequency size. The operations of 1710 may be performed in accordance with examples as disclosed herein. In some examples, aspects of the operations of 1710 may be performed by a CORESET mapping manager 1235 as described with reference to FIG. 12.

At 1715, the method may include transmitting a second control message to the UE within the additional CORESET based at least in part on the mapping, the second control message scheduling the UE to receive a SIB. The operations of 1715 may be performed in accordance with examples as disclosed herein. In some examples, aspects of the operations of 1715 may be performed by a control message transmitting manager 1225 as described with reference to FIG. 12.

The following provides an overview of aspects of the present disclosure:

Aspect 1: A method for wireless communication at a UE, comprising: receiving, from a network entity, a control message indicating a CORESET, wherein the CORESET is associated with a downlink bandwidth part spanning a plurality of sub-bands in a frequency domain; selecting a sub-band of the plurality of sub-bands based at least in part on a PCID associated with the UE; monitoring the selected sub-band for control signaling that schedules the UE to receive a SIB; and receiving a second control message from the network entity within the selected sub-band based at least in part on monitoring the selected sub-band, the second control message scheduling the UE to receive the SIB.

Aspect 2: The method of aspect 1, wherein each sub-band of the plurality of sub-bands is associated with a respective sub-band identifier, the method further comprising: selecting the sub-band associated with a lowest sub-band identifier from the plurality of sub-bands based at least in part on the PCID comprising an odd numbered PCID, or selecting the sub-band associated with a highest sub-band identifier from the plurality of sub-bands based at least in part on the PCID comprising an even numbered PCID.

Aspect 3: The method of any of aspects 1 through 2, further comprising: selecting the sub-band based at least in part on a quantity of sub-bands included within the plurality of sub-bands and based at least in part on the PCID.

Aspect 4: The method of any of aspects 1 through 3, further comprising: receiving, from the network entity, a SSB indicating the PCID, wherein selecting the sub-band is based at least in part on receiving the SSB.

Aspect 5: The method of any of aspects 1 through 4, further comprising: receiving, from the network entity, a SSB indicating a sub-band configuration usable by the UE for selecting the sub-band from the plurality of sub-bands, wherein the sub-band is selected from the plurality of sub-bands in accordance with the sub-band configuration.

Aspect 6: The method of any of aspects 1 through 5, wherein the control message comprises a MIB.

Aspect 7: The method of any of aspects 1 through 6, wherein selecting the sub-band of the plurality of sub-bands is based at least in part on the UE comprising an eRedCap UE.

Aspect 8: A method for wireless communication at network entity, comprising: transmitting, to a UE, a control message indicating a CORESET, wherein the CORESET is associated with a downlink bandwidth part spanning a plurality of sub-bands in a frequency domain; identifying a sub-band of the plurality of sub-bands of the downlink bandwidth part associated with the CORESET based at least in part on a PCID associated with the UE; and transmitting a second control message to the UE within the identified sub-band, the second control message scheduling the UE to receive a SIB.

Aspect 9: The method of aspect 8, wherein each sub-band of the plurality of sub-bands is associated with a respective sub-band identifier, the method further comprising: identifying the sub-band associated with a lowest sub-band identifier from the plurality of sub-bands based at least in part on the PCID comprising an odd numbered PCID, or identifying the sub-band associated with a highest sub-band identifier from the plurality of sub-bands based at least in part on the PCID comprising an even numbered PCID.

Aspect 10: The method of any of aspects 8 through 9, further comprising: identifying the sub-band based at least in part on a quantity of sub-bands included within the plurality of sub-bands.

Aspect 11: The method of any of aspects 8 through 10, further comprising: transmitting, to the UE, a SSB indicating the PCID, wherein identifying the sub-band, transmitting the second control message, or both, is based at least in part on transmitting the SSB.

Aspect 12: The method of any of aspects 8 through 11, further comprising: transmitting, to the UE, a SSB indicating a sub-band configuration usable by the UE for selecting the sub-band from the plurality of sub-bands, wherein the sub-band is identified from the plurality of sub-bands in accordance with the sub-band configuration.

Aspect 13: The method of any of aspects 8 through 12, wherein the control message comprises a MIB.

Aspect 14: The method of any of aspects 8 through 13, wherein identifying the sub-band from the plurality of sub-bands is based at least in part on the UE comprising an eRedCap UE.

Aspect 15: A method for wireless communication at a UE, comprising: receiving, from a network entity, a control message indicating a CORESET associated with a first set of resources that span a first frequency range; mapping the CORESET to an additional CORESET associated with a second set of resources that span a second frequency range that is smaller than the first frequency range based at least in part on the first frequency range exceeding a threshold frequency size; monitoring, based at least in part on the mapping, the additional CORESET for control signaling that schedules the UE to receive a SIB; and receiving a second control message from the network entity within the additional CORESET based at least in part on monitoring the additional CORESET, the second control message scheduling the UE to receive the SIB.

Aspect 16: The method of aspect 15, further comprising: receiving a CORESET mapping configuration for mapping CORESETs, wherein the first CORESET is mapped to the second CORESET in accordance with the CORESET mapping configuration.

Aspect 17: The method of any of aspects 15 through 16, wherein the first set of resources associated with the CORESET spans a first set of symbols in a time domain, and the second set of resources associated with the additional CORESET spans a second set of symbols in the time domain that is greater than the first set of symbols.

Aspect 18: The method of any of aspects 15 through 17, further comprising: receiving, via the control message, a first CORESET index associated with the CORESET; and mapping the first CORESET index to a second CORESET index associated with the additional CORESET.

Aspect 19: The method of aspect 18, further comprising: receiving a data object comprising a plurality of CORESET indices corresponding to a plurality of CORESET indices, wherein mapping the first CORESET index to the second CORESET index is based at least in part on referencing the data object.

Aspect 20: The method of any of aspects 15 through 19, wherein mapping the CORESET to the additional CORESET is based at least in part on a set of parameters, the set of parameters comprise a quantity of CORESETs that are capable of being monitored by the UE, a first quantity of symbols spanned by the CORESET in a time domain, a second quantity of symbols spanned by the additional CORESET in the time domain, a resource block offset value, or any combination thereof.

Aspect 21: The method of any of aspects 15 through 20, further comprising: receiving, from the network entity, a third control message indicating a third CORESET associated with a third set of resources that span a third frequency range; monitoring the third CORESET for additional control signaling based at least in part on the third frequency range failing to satisfy a threshold frequency range associated with the UE; and receiving a fourth control message from the network entity within the third CORESET based at least in part on monitoring the third CORESET.

Aspect 22: The method of any of aspects 15 through 21, wherein the control message comprises a MIB.

Aspect 23: A method for wireless communication at a network entity, comprising: transmitting, to a UE, a control message indicating a CORESET associated with a first set of resources that span a first frequency range; mapping the CORESET to an additional CORESET associated with a second set of resources that span a second frequency range that is smaller than the first frequency range based at least in part on the first frequency range exceeding a threshold frequency size; and transmitting a second control message to the UE within the additional CORESET based at least in part on the mapping, the second control message scheduling the UE to receive a SIB.

Aspect 24: The method of aspect 23, further comprising: transmitting a CORESET mapping configuration for mapping CORESETs, wherein the first CORESET is mapped to the second CORESET in accordance with the CORESET mapping configuration.

Aspect 25: The method of any of aspects 23 through 24, wherein the first set of resources associated with the CORESET spans a first set of symbols in a time domain, and the second set of resources associated with the additional CORESET spans a second set of symbols in the time domain that is greater than the first set of symbols.

Aspect 26: The method of any of aspects 23 through 25, further comprising: transmitting, via the control message, a first CORESET index associated with the CORESET; and mapping the first CORESET index to a second CORESET index associated with the additional CORESET.

Aspect 27: The method of aspect 26, further comprising: transmitting, to the UE, a data object comprising a plurality of CORESET indices corresponding to a plurality of CORESET indices, wherein mapping the first CORESET index to the second CORESET index is based at least in part on referencing the data object.

Aspect 28: The method of any of aspects 23 through 27, wherein mapping the CORESET to the additional CORESET is based at least in part on a set of parameters, the set of parameters comprise a quantity of CORESETs that are capable of being monitored by the UE, a first quantity of symbols spanned by the CORESET in a time domain, a second quantity of symbols spanned by the additional CORESET in the time domain, a resource block offset value, or any combination thereof.

Aspect 29: The method of any of aspects 23 through 28, further comprising: transmitting, to the UE, a third control message indicating a third CORESET associated with a third set of resources that span a third frequency range; and transmitting a fourth control message to the UE within the third CORESET based at least in part on the third frequency range failing to satisfy a threshold frequency range associated with the UE.

Aspect 30: The method of any of aspects 23 through 29, wherein the control message comprises a MIB.

Aspect 31: An apparatus for wireless communication at a UE, comprising at least one processor, and memory coupled to the at least one processor, the memory storing instructions executable by the at least one processor to cause the UE to perform a method of any of aspects 1 through 7.

Aspect 32: An apparatus for wireless communication at a UE, comprising at least one means for performing a method of any of aspects 1 through 7.

Aspect 33: A non-transitory computer-readable medium storing code for wireless communication at a UE, the code comprising instructions executable by a processor to perform a method of any of aspects 1 through 7.

Aspect 34: An apparatus for wireless communication at network entity, comprising at least one processor, and memory coupled to the at least one processor, the memory storing instructions executable by the at least one processor to cause the network entity to perform a method of any of aspects 8 through 14.

Aspect 35: An apparatus for wireless communication at network entity, comprising at least one means for performing a method of any of aspects 8 through 14.

Aspect 36: A non-transitory computer-readable medium storing code for wireless communication at network entity, the code comprising instructions executable by a processor to perform a method of any of aspects 8 through 14.

Aspect 37: An apparatus for wireless communication at a UE, comprising at least one processor, and memory coupled to the at least one processor, the memory storing instructions executable by the at least one processor to cause the UE to perform a method of any of aspects 15 through 22.

Aspect 38: An apparatus for wireless communication at a UE, comprising at least one means for performing a method of any of aspects 15 through 22.

Aspect 39: A non-transitory computer-readable medium storing code for wireless communication at a UE, the code comprising instructions executable by a processor to perform a method of any of aspects 15 through 22.

Aspect 40: An apparatus for wireless communication at a network entity, comprising at least one processor, and memory coupled to the at least one processor, the memory storing instructions executable by the at least one processor to cause the network entity to perform a method of any of aspects 23 through 30.

Aspect 41: An apparatus for wireless communication at a network entity, comprising at least one means for performing a method of any of aspects 23 through 30.

Aspect 42: A non-transitory computer-readable medium storing code for wireless communication at a network entity, the code comprising instructions executable by a processor to perform a method of any of aspects 23 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled to the at least one processor, the memory storing instructions executable by the at least one processor to cause the UE to:
receive, from a network entity, a control message indicating a control resource set, wherein the control resource set is associated with a downlink bandwidth part spanning a plurality of sub-bands in a frequency domain;
select a sub-band of the plurality of sub-bands based at least in part on a physical cell identifier associated with the UE;
monitor the selected sub-band for control signaling that schedules the UE to receive a system information block; and
receive a second control message from the network entity within the selected sub-band based at least in part on monitoring the selected sub-band, the second control message scheduling the UE to receive the system information block.

2. The apparatus of claim 1, wherein each sub-band of the plurality of sub-bands is associated with a respective sub-band identifier, and the instructions are further executable by the at least one processor to cause the UE to:
select the sub-band associated with a lowest sub-band identifier from the plurality of sub-bands based at least in part on the physical cell identifier comprising an odd numbered physical cell identifier, or
select the sub-band associated with a highest sub-band identifier from the plurality of sub-bands based at least in part on the physical cell identifier comprising an even numbered physical cell identifier.

3. The apparatus of claim 1, wherein the instructions are further executable by the at least one processor to cause the UE to:
select the sub-band based at least in part on a quantity of sub-bands included within the plurality of sub-bands and based at least in part on the physical cell identifier.

4. The apparatus of claim 1, wherein the instructions are further executable by the at least one processor to cause the UE to:
receive, from the network entity, a synchronization signal block indicating the physical cell identifier, wherein selecting the sub-band is based at least in part on receiving the synchronization signal block.

5. The apparatus of claim 1, wherein the instructions are further executable by the at least one processor to cause the UE to:
receive, from the network entity, a synchronization signal block indicating a sub-band configuration usable by the UE for selecting the sub-band from the plurality of sub-bands, wherein the sub-band is selected from the plurality of sub-bands in accordance with the sub-band configuration.

6. The apparatus of claim 1, wherein the control message comprises a master information block.

7. The apparatus of claim 1, wherein selecting the sub-band of the plurality of sub-bands is based at least in part on the UE comprising an enhanced reduced-capability UE.

8. An apparatus for wireless communication at network entity, comprising:
at least one processor; and
memory coupled to the at least one processor, the memory storing instructions executable by the at least one processor to cause the network entity to:
transmit, to a user equipment (UE), a control message indicating a control resource set, wherein the control resource set is associated with a downlink bandwidth part spanning a plurality of sub-bands in a frequency domain;
identify a sub-band of the plurality of sub-bands of the downlink bandwidth part associated with the control resource set based at least in part on a physical cell identifier associated with the UE; and
transmit a second control message to the UE within the identified sub-band, the second control message scheduling the UE to receive a system information block.

9. The apparatus of claim 8, wherein each sub-band of the plurality of sub-bands is associated with a respective sub-band identifier, and the instructions are further executable by the at least one processor to cause the network entity to:
identify the sub-band associated with a lowest sub-band identifier from the plurality of sub-bands based at least in part on the physical cell identifier comprising an odd numbered physical cell identifier, or
identify the sub-band associated with a highest sub-band identifier from the plurality of sub-bands based at least in part on the physical cell identifier comprising an even numbered physical cell identifier.

10. The apparatus of claim 8, wherein the instructions are further executable by the at least one processor to cause the network entity to:
identify the sub-band based at least in part on a quantity of sub-bands included within the plurality of sub-bands.

11. The apparatus of claim 8, wherein the instructions are further executable by the at least one processor to cause the network entity to:
transmit, to the UE, a synchronization signal block indicating the physical cell identifier, wherein identifying the sub-band, transmitting the second control message, or both, is based at least in part on transmitting the synchronization signal block.

12. The apparatus of claim 8, wherein the instructions are further executable by the at least one processor to cause the network entity to:
transmit, to the UE, a synchronization signal block indicating a sub-band configuration usable by the UE for selecting the sub-band from the plurality of sub-bands, wherein the sub-band is identified from the plurality of sub-bands in accordance with the sub-band configuration.

13. The apparatus of claim 8, wherein the control message comprises a master information block.

14. The apparatus of claim 8, wherein identifying the sub-band from the plurality of sub-bands is based at least in part on the UE comprising an enhanced reduced-capability UE.

15. An apparatus for wireless communication at a user equipment (UE), comprising:
at least one processor; and
memory coupled to the at least one processor, the memory storing instructions executable by the at least one processor to cause the UE to:
receive, from a network entity, a control message indicating a control resource set associated with a first set of resources that span a first frequency range;
map the control resource set to an additional control resource set associated with a second set of resources that span a second frequency range that is smaller than the first frequency range based at least in part on the first frequency range exceeding a threshold frequency size;
monitor, based at least in part on the mapping, the additional control resource set for control signaling that schedules the UE to receive a system information block; and
receive a second control message from the network entity within the additional control resource set based at least in part on monitoring the additional control resource set, the second control message scheduling the UE to receive the system information block.

16. The apparatus of claim 15, wherein the instructions are further executable by the at least one processor to cause the UE to:
receive a control resource set mapping configuration for mapping control resource sets, wherein the first control resource set is mapped to the second control resource set in accordance with the control resource set mapping configuration.

17. The apparatus of claim 15, wherein the first set of resources associated with the control resource set spans a first set of symbols in a time domain, and wherein the second set of resources associated with the additional control resource set spans a second set of symbols in the time domain that is greater than the first set of symbols.

18. The apparatus of claim 15, wherein the instructions are further executable by the at least one processor to cause the UE to:
receive, via the control message, a first control resource set index associated with the control resource set; and
map the first control resource set index to a second control resource set index associated with the additional control resource set.

19. The apparatus of claim 18, wherein the instructions are further executable by the at least one processor to cause the UE to:
receive a data object comprising a plurality of control resource set indices corresponding to a plurality of control resource set indices, wherein mapping the first control resource set index to the second control resource set index is based at least in part on referencing the data object.

20. The apparatus of claim 15, wherein mapping the control resource set to the additional control resource set is based at least in part on a set of parameters, wherein the set of parameters comprise a quantity of control resource sets that are capable of being monitored by the UE, a first quantity of symbols spanned by the control resource set in a time domain, a second quantity of symbols spanned by the additional control resource set in the time domain, a resource block offset value, or any combination thereof.

21. The apparatus of claim 15, wherein the instructions are further executable by the at least one processor to cause the UE to:
receive, from the network entity, a third control message indicating a third control resource set associated with a third set of resources that span a third frequency range;
monitor the third control resource set for additional control signaling based at least in part on the third frequency range failing to satisfy a threshold frequency range associated with the UE; and
receive a fourth control message from the network entity within the third control resource set based at least in part on monitoring the third control resource set.

22. The apparatus of claim 15, wherein the control message comprises a master information block.

23. An apparatus for wireless communication at a network entity, comprising:
at least one processor; and
memory coupled to the at least one processor, the memory storing instructions executable by the at least one processor to cause the network entity to:
transmit, to a user equipment (UE), a control message indicating a control resource set associated with a first set of resources that span a first frequency range;
map the control resource set to an additional control resource set associated with a second set of resources that span a second frequency range that is smaller than the first frequency range based at least in part on the first frequency range exceeding a threshold frequency size; and
transmit a second control message to the UE within the additional control resource set based at least in part on the mapping, the second control message scheduling the UE to receive a system information block.

24. The apparatus of claim 23, wherein the instructions are further executable by the at least one processor to cause the network entity to:
transmit a control resource set mapping configuration for mapping control resource sets, wherein the first control resource set is mapped to the second control resource set in accordance with the control resource set mapping configuration.

25. The apparatus of claim 23, wherein the first set of resources associated with the control resource set spans a first set of symbols in a time domain, and wherein the second set of resources associated with the additional control resource set spans a second set of symbols in the time domain that is greater than the first set of symbols.

26. The apparatus of claim 23, wherein the instructions are further executable by the at least one processor to cause the network entity to:
transmit, via the control message, a first control resource set index associated with the control resource set; and
map the first control resource set index to a second control resource set index associated with the additional control resource set.

27. The apparatus of claim 26, wherein the instructions are further executable by the at least one processor to cause the network entity to:
transmit, to the UE, a data object comprising a plurality of control resource set indices corresponding to a plurality of control resource set indices, wherein mapping the first control resource set index to the second control resource set index is based at least in part on referencing the data object.

28. The apparatus of claim 23, wherein mapping the control resource set to the additional control resource set is based at least in part on a set of parameters, wherein the set of parameters comprise a quantity of control resource sets that are capable of being monitored by the UE, a first quantity of symbols spanned by the control resource set in a time domain, a second quantity of symbols spanned by the additional control resource set in the time domain, a resource block offset value, or any combination thereof.

29. The apparatus of claim 23, wherein the instructions are further executable by the at least one processor to cause the network entity to:
transmit, to the UE, a third control message indicating a third control resource set associated with a third set of resources that span a third frequency range; and
transmit a fourth control message to the UE within the third control resource set based at least in part on the third frequency range failing to satisfy a threshold frequency range associated with the UE.

30. The apparatus of claim 23, wherein the control message comprises a master information block.
